(19) United States
(12) Patent Application Publication
(10) Pub. No.: US 2025/0048259 A1
(43) Pub. Date: Feb. 6, 2025

(54) SYSTEM AND METHODS FOR NETWORK ENERGY SAVING

(71) Applicant: Huawei Technologies Co., Ltd., Shenzhen (CN)

(72) Inventors: Jialing Liu, Palatine, IL (US); Weimin Xiao, Hoffman Estates, IL (US)

(21) Appl. No.: 18/927,429

(22) Filed: Oct. 25, 2024

Related U.S. Application Data
(63) Continuation of application No. PCT/US2023/016795, filed on Mar. 30, 2023.
(60) Provisional application No. 63/336,080, filed on Apr. 28, 2022.
(60) Provisional application No. 63/371,182, filed on Aug. 11, 2022.

(51) Int. Cl. H04W 52/02; H04W 72/232

(52) U.S. Cl. CPC H04W 52/0206; H04W 72/232

(57) ABSTRACT

In accordance with an embodiment, a method includes receiving, from a base station, configuration information of a first set of resources for a user equipment (UE). The configuration information includes a first parameter for the first set of the resources. The method further includes receiving, from the base station, first group signaling that assigns a first value to the first parameter for the first set of the resources. The method further includes communicating with the first set of the resources in accordance with the first value for the first parameter.

### PRIORITY CLAIM AND CROSS-REFERENCE

This patent application is a continuation of PCT/US2023/016795 filed on Mar. 30, 2023, and entitled “Systems and Methods for Network Energy Saving,” which claims priority to U.S. Provisional Application No. 63/336,080, filed on Apr. 28, 2022, and entitled “Methods and Apparatus for Network Energy Saving,” and U.S. Provisional Application No. 63/371,182, filed on Aug. 11, 2022, and entitled “System and Methods for Network Energy Saving,” which applications are hereby incorporated by reference herein as if reproduced in their entireties.

### TECHNICAL FIELD

The present invention relates generally to managing the allocation of resources in a network, and in particular embodiments, to techniques and mechanisms for system and methods for network energy saving.

### BACKGROUND

Wireless communication systems include long term evolution (LTE), LTE-A, LTE-A-beyond systems, 5G LTE, 5G New Radio (NR), etc. A modern wireless communication system may include a plurality of NodeBs (NBs), which may also be referred to as base stations, network nodes, communications controllers, cells or enhanced NBs (eNBs), 5G NR gNodeBs (gNBs) and so on. A NodeB may include one or more network points or network nodes using different radio access technologies (RATs) such as high speed packet access (HSPA) NBs or WiFi access points. A NodeB may be associated with a single network point or multiple network points. A cell may include a single network point or multiple network points, and each network point may have a single antenna or multiple antennas. A network point may correspond to multiple cells operating in multiple component carriers. Generally each component carrier in carrier aggregation is a serving cell, either a primary cell (PCell) or a secondary cell (SCell).

A cell or NodeB may serve a number of users (also commonly referred to as User Equipment (UE), mobile stations, terminals, devices, and so forth) over a period of time. A communication channel from a NB to a UE is generally referred to as a downlink (DL) channel, and a transmission from the NB to the UE is a downlink transmission. A communication channel from a UE to a NB is generally referred to an uplink (UL) channel, and a transmission from the UE to the NB is an uplink transmission.

### SUMMARY OF THE INVENTION

Technical advantages are generally achieved, by embodiments of this disclosure which describe system and methods for network energy saving.

In accordance with an embodiment, a method includes: receiving, from a base station, a first set of resources for a User Equipment (UE); receiving, from the base station, configurations of states for the first set of the resources; receiving, from the base station, group signaling for transitioning the first set of the resources to a first state of the states; and communicating with the first set of the resources in the first state. In some embodiments, the method further includes: before receiving the configurations of the states for the first set of the resources, communicating with the first set of the resources in a default state. In accordance with another embodiment, a method includes: receiving, from a base station, configuration information of a first set of resources for a User Equipment (UE), the configuration information including a first parameter for the first set of the resources; receiving, from the base station, first group signaling that assigns a first value to the first parameter for the first set of the resources; and communicating with the first set of the resources in accordance with the first value for the first parameter. In some embodiments of the method, the first set of the resources includes resources of one or more secondary cells, resources of one or more serving cells, resources of one or more carriers, resources of one or more control resource sets (CORESETs), or resources of one or more bandwidth parts (BWPs). In some embodiments of the method, the first set of the resources includes resources of one or more BWPs, and the resources of one or more BWPs are resources of one or more initial downlink BWPs or initial uplink BWPs. In some embodiments of the method, the first set of the resources includes one or more first signals, the one or more first signals being one or more synchronization signal blocks (SSBs) with one or more SSB indexes, one or more channel state information reference signals (CSI-RSs), one or more tracking reference signals, or one or more SRSs. In some embodiments of the method, the first set of the resources further includes a second signal that is quasi co-located (QCLed) with one of the one or more first signals or is configured with a transmission configuration indication (TCI) state including a reference being one of the one or more first signals, the second signal including a downlink (DL) channel, a DL signal, an uplink (UL) channel, or an UL signal. In some embodiments, the method further includes: deactivating the first set of the resources by deactivating a first resource of the first set of the resources and deactivating others of the first set of the resources that are configured with a transmission configuration indication (TCI) state including a reference being the first resource. In some embodiments, the method further includes: activating the first set of the resources by activating a first resource of the first set of the resources and activating others of the first set of the resources that are configured with a transmission configuration indication (TCI) state including a reference being the first resource. In some embodiments, the method further includes: suspending communication with the first set of the resources for a duration in accordance with a duration value received from the base station. In some embodiments of the method, receiving the first group signaling includes receiving a group-common downlink control information (GC-DCI). In some embodiments of the method, receiving the first group signaling includes receiving a medium access control (MAC) control element (CE). In some embodiments of the method, receiving the first group signaling includes receiving one of a cell-specific signaling, a cell-specific information element signaling, a common information element signaling, an information element signaling for a synchronization signal block (SSB), an information element signaling for a master information block (MIB), or an information element signaling for a system information block (SIB). In some embodiments of the method, receiving the first group signaling includes receiving a group-common downlink control information (GC-DCI) scheduling a group physical downlink shared channel (PDSCH) with a medium access control (MAC) control element (CE), a cell-specific signaling, a cell-specific information element signaling, or a common information element signaling. In some embodiments of the method, receiving the first group signaling further includes receiving aperiodic group signaling. In some embodiments of the method, the first group signaling includes an activity level identifier of the first set of the resources, an increase or decrease in activity level of the first set of the resources, a value corresponding to a deactivation of the first set of the resources, or a value corresponding to an activation of the first set of the resources. In some embodiments of the method, the first parameter is associated with a timing for the first value, a duration for the first value, or a duration of suspending communication with the first set of the resources. In some embodiments, the method further includes: before receiving the first group signaling that assigns the first value to the first parameter, communicating with the first set of the resources in accordance with a default value for the first parameter. In some embodiments of the method, the first set of the resources is configured with an identifier by a RRC configuration signaling, and the first group signaling indicates the identifier of the first set of the resources. In some embodiments of the method, the first set of the resources is configured with a bit field in the first group signaling by a RRC configuration signaling, and the first group signaling indicates the first value in the bit field. In some embodiments, the method further includes: upon receiving the first group signaling, activating the first set of the resources in accordance with the first value, and deactivating a second set of resources that was activated before receiving the first group signaling. In some embodiments, the method further includes: upon receiving the first group signaling, deactivating the first set of the resources in accordance with the first value, and activating a second set of resources that was deactivated before receiving the first group signaling. In some embodiments, the method further includes: upon receiving the first group signaling, deactivating the first set of the resources in accordance with the first value; receiving, from the base station, second group signaling that assigns a second value to the first parameter for the first set of the resources; and upon receiving the second group signaling, activating the first set of the resources in accordance with the second value. In accordance with another embodiment, a User Equipment (UE) includes: a processor; and a non-transitory computer readable storage medium storing programming for execution by the processor, the programming including instructions to perform any of the forgoing methods.

In accordance with an embodiment, a method includes: transmitting, by a base station, a first set of resources for a User Equipment (UE); transmitting, by the base station, configurations of states for the first set of the resources; transmitting, by the base station, group signaling for transitioning the first set of the resources to a first state of the states; and communicating with the first set of the resources in the first state. In some embodiments, the method further includes: before transmitting the configurations of the states for the first set of the resources, communicating with the first set of the resources in a default state. In accordance with another embodiment, a method includes: transmitting, by a base station, configuration information of a first set of resources for a User Equipment (UE), the configuration information including a first parameter for the first set of the resources; transmitting, by the base station, first group signaling that assigns a first value to the first parameter for the first set of the resources; and communicating with the first set of the resources in accordance with the first value for the first parameter. In some embodiments of the method, the first set of the resources includes resources of one or more secondary cells, resources of one or more serving cells, resources of one or more carriers, resources of one or more control resource sets (CORESETs), or resources of one or more bandwidth parts (BWPs). In some embodiments of the method, the first set of the resources includes resources of one or more BWPs, and the resources of one or more BWPs are resources of one or more initial downlink BWPs or initial uplink BWPs. In some embodiments of the method, the first set of the resources includes one or more first signals, the one or more first signals being one or more synchronization signal blocks (SSBs) with one or more SSB indexes, one or more channel state information reference signals (CSI-RSs), one or more tracking reference signals, or one or more SRSs. In some embodiments of the method, the first set of the resources further includes a second signal that is quasi co-located (QCLed) with one of the one or more first signals or is configured with a transmission configuration indication (TCI) state including a reference being one of the one or more first signals, the second signal including a downlink (DL) channel, a DL signal, an uplink (UL) channel, or an UL signal. In some embodiments, the method further includes: deactivating the first set of the resources by deactivating a first resource of the first set of the resources and deactivating others of the first set of the resources that are configured with a transmission configuration indication (TCI) state including a reference being the first resource. In some embodiments, the method further includes: activating the first set of the resources by activating a first resource of the first set of the resources and activating others of the first set of the resources that are configured with a transmission configuration indication (TCI) state including a reference being the first resource. In some embodiments, the method further includes: suspending communication with the first set of the resources for a duration in accordance with a duration value transmitted by the base station. In some embodiments of the method, transmitting the first group signaling includes transmitting a group-common downlink control information (GC-DCI). In some embodiments of the method, transmitting the first group signaling includes transmitting a medium access control (MAC) control element (CE). In some embodiments of the method, transmitting the first group signaling includes transmitting one of a cell-specific signaling, a cell-specific information element signaling, a common information element signaling, an information element signaling for a synchronization signal block (SSB), an information element signaling for a master information block (MIB), or an information element signaling for a system information block (SIB). In some embodiments of the method, transmitting the first group signaling includes transmitting a group-common downlink control information (GC-DCI) scheduling a group physical downlink shared channel (PDSCH) with a medium access control (MAC) control element (CE), a cell-specific signaling, a cell-specific information element signaling, or a common information element signaling. In some embodiments of the method, transmitting the first group signaling further includes transmitting aperiodic group signaling. In some embodiments of the method, the first group signaling includes an activity level identifier of the first set of the resources, an increase or decrease in activity level of the first set of the resources, a value corresponding to a deactivation of the first set of the resources, or a value corresponding to an activation of the first set of the resources. In some embodiments of the method, the first parameter is associated with a timing for the first value, a duration for the first value, or a duration of suspending communication with the first set of the resources. In some embodiments, the method further includes: before transmitting the first group signaling that assigns the first value to the first parameter, communicating with the first set of the resources in accordance with a default value for the first parameter. In some embodiments of the method, the first set of the resources is configured with an identifier by a RRC configuration signaling, and the first group signaling indicates the identifier of the first set of the resources. In some embodiments of the method, the first set of the resources is configured with a bit field in the first group signaling by a RRC configuration signaling, and the first group signaling indicates the first value in the bit field. In some embodiments, the method further includes: upon transmitting the first group signaling, activating the first set of the resources in accordance with the first value, and deactivating a second set of resources that was activated before transmitting the first group signaling. In some embodiments, the method further includes: upon transmitting the first group signaling, deactivating the first set of the resources in accordance with the first value, and activating a second set of resources that was deactivated before transmitting the first group signaling. In some embodiments, the method further includes: upon transmitting the first group signaling, deactivating the first set of the resources in accordance with the first value; transmitting, by the base station, second group signaling that assigns a second value to the first parameter for the first set of the resources; and upon transmitting the second group signaling, activating the first set of the resources in accordance with the second value. In accordance with another embodiment, a base station includes: a processor; and a non-transitory computer readable storage medium storing programming for execution by the processor, the programming including instructions to perform any of the forgoing methods.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example wireless communication system, according to some embodiments;

FIG. 1B illustrates the use of carrier aggregation (CA), according to some embodiments;

FIG. 2A illustrates physical layer channels and signals for wireless communication, according to some embodiments;

FIG. 2B illustrates signals/channels which are multiplexed for more than one UE, according to some embodiments;

FIG. 2C illustrates examples of non-zero power (NZP) channel state information reference signal (CSI-RS) used for channel estimation, interference measurement, and so on, which are multiplexed with physical downlink shared channel (PDSCH) and for one or more UEs, according to some embodiments;

FIG. 3A is a diagram showing QCL assumptions among NR reference signals when wide beams are used for communications, according to some embodiments;

FIG. 3B is a diagram showing QCL assumptions among NR reference signals when narrow beams are used for communications, according to some embodiments;

FIG. 4 is a power consumption model for a base station, according to some embodiments;

FIG. 5 is a diagram of air-interface resources for power states, according to some embodiments;

FIG. 6 is a power consumption model for a base station, according to some other embodiments;

FIG. 7A illustrates relative power consumption of a base station at various states, according to some embodiments;

FIG. 7B illustrates relative activity of a UE at various states, according to some embodiments;

FIG. 8 is a protocol diagram of operations in a wireless communication system during state transitions, according to some embodiments;

FIG. 9A is a flow diagram of a network adaptation method, according to some embodiments;

FIG. 9B is a flow diagram of a network adaptation method, according to some embodiments;

FIG. 10A is a flow diagram of a network adaptation method, according to some embodiments;

FIG. 10B is a flow diagram of a network adaptation method, according to some embodiments;

FIG. 11 illustrates an example communication system according to example embodiments presented herein;

FIGS. 12A and 12B illustrate example devices that may implement the methods and teachings according to this disclosure, according to some embodiments; and

FIG. 13 is a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

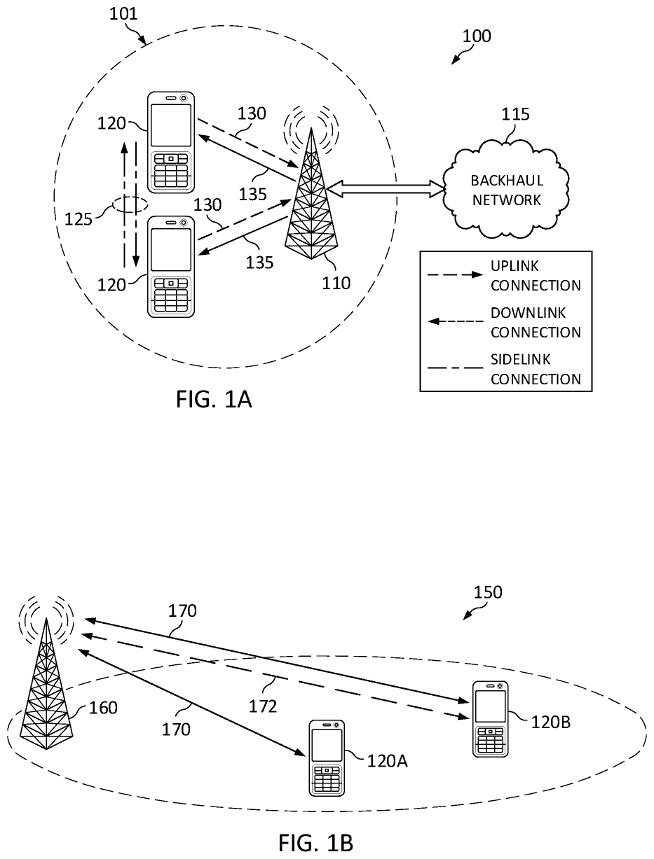

FIG. 1A illustrates an example of a wireless communication system 100. The wireless communication system 100 includes a base station 110 with coverage area 101. The base station 110 serves a plurality of user equipments (UEs), including UEs 120. Transmissions from the base station no to a UE is referred to as a downlink (DL) transmission and occurs over a downlink channel (shown in FIG. 1A as a solid arrowed line 135), while transmissions from a UE to the base station no is referred to as an uplink (UL) transmission and occurs over an uplink channel (shown in FIG. 1A as a dashed arrowed line 130). Data carried over the uplink/downlink connections may include data communicated between the UEs 120, as well as data communicated to/from a remote-end (not shown) by way of a backhaul network 115. Example uplink channels and signals include physical uplink shared channel (PUSCH), physical uplink control channel (PUCCH), an uplink sounding reference signal (SRS), or physical random access channel (PRACH). Services may be provided to the plurality of UEs by service providers connected to the base station no through the backhaul network 115, such as the Internet. The wireless communication system 100 may include multiple distributed access nodes, e.g., base stations no.

In a typical communication system, there are several operating modes. In a cellular operating mode, communications to and from the plurality of UEs go through the base station no, while in device to device communications mode, such as proximity services (ProSe) operating mode, for example, direct communication between UEs is possible. As used herein, the term “base station” refers to any component (or collection of components) configured to provide wireless access to a network. Base stations may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, access nodes, access points (APs), transmission points (TPs), transmission-reception points (TRPs), cells, carriers, macro cells, femtocells, pico cells, relays, customer premises equipment (CPE), the network side, the network, and so on. In the present disclosure, the terms “base station” and “TRP” are used interchangeably unless otherwise specified. As used herein, the term “UE” refers to any component (or collection of components) capable of establishing a wireless connection with a base station. UEs may also be commonly referred to as mobile stations, mobile devices, mobiles, terminals, user terminals, users, subscribers, stations, communication devices, CPEs, relays, Integrated Access and Backhaul (JAB) relays, and the like. It is noted that when relaying is used (based on relays, picos, CPEs, and so on), especially multi-hop relaying, the boundary between a controller and a node controlled by the controller may become blurry, and a dual node (e.g., either the controller or the node controlled by the controller) deployment where a first node that provides configuration or control information to a second node is considered to be the controller. Likewise, the concept of UL and DL transmissions can be extended as well.

A cell may include one or more bandwidth parts (BWPs) for UL or DL allocated for a UE. Each BWP may have its own BWP-specific numerology and configuration, such as the BWP's bandwidth. It is noted that not all BWPs need to be active at the same time for the UE. A cell may correspond to one carrier, and in some cases, multiple carriers. Typically, one cell (a primary cell (PCell) or a secondary cell (SCell), for example) is a component carrier (a primary component carrier (PCC) or a secondary CC (SCC), for example). For some cells, each cell may include multiple carriers in UL, one carrier may be referred to as an UL carrier or non-supplementary UL (non-SUL, or simply UL) carrier which has an associated DL, and other carriers are called supplementary UL (SUL) carriers which do not have an associated DL. A cell, or a carrier, may be configured with slot or subframe formats comprising DL and UL symbols, and that cell or carrier may be seen as operating in a time division duplexed (TDD) mode. In general, for unpaired spectrum, the cells or carriers are in TDD mode, and for paired spectrum, the cells or carrier are in a frequency division duplexed (FDD) mode. A transmission time interval (TTI) generally corresponds to a subframe (in LTE) or a slot (in NR). Access nodes may provide wireless access in accordance with one or more wireless communication protocols, e.g., long term evolution (LTE), LTE advanced (LTE-A), 5G, 5G LTE, 5G NR, future 5G NR releases, 6G, High Speed Packet Access (HSPA), Wi-Fi 802.11a/b/g/n/ac, etc. While it is understood that communication systems may employ multiple access nodes (or base stations) capable of communicating with a number of UEs, only one access node, and two UEs are illustrated in FIG. 1 for simplicity.

A way to increase the network resources is to utilize more usable spectrum resources, which include not only the licensed spectrum resources of the same type as the macro, but also the licensed spectrum resources of different type as the macro (e.g., the macro is a FDD cell but a small cell may use both FDD and TDD carriers), as well as unlicensed spectrum resources and shared-licensed spectrums. Some of the spectrum resources lie in high-frequency bands, such as 6 GHz to 60 GHz. The unlicensed spectrums may be used by generally any user, subject to regulatory requirements. The shared-licensed spectrums are also not exclusive for an operator to use. Traditionally, the unlicensed spectrums are not used by cellular networks because it is generally difficult to ensure quality of service (QoS) requirements. Operating on the unlicensed spectrums mainly includes wireless local area networks (WLAN), e.g., the Wi-Fi networks. Due to the fact that the licensed spectrum is generally scarce and expensive, utilizing the unlicensed spectrum by the cellular operator may be considered. Note that on high-frequency bands and unlicensed/shared-licensed bands, typically TDD is used and hence the channel reciprocity can be exploited for the communications.

In a realistic deployment, a gNB may control one or more cells. Multiple remote radio units may be connected to the same base band unit of the gNB by fiber cable, and the latency between base band unit and remote radio unit is quite small. Therefore, the same base band unit can process the coordinated transmission/reception of multiple cells. For example, the gNB may coordinate the transmissions of multiple cells to a UE, which is called coordinated multiple point (CoMP) or multi-TRP (mTRP, M-TRP) transmission. The gNB may also coordinate the reception of multiple cells from a UE, which is called CoMP/M-TRP reception. In this case, the backhaul link between these cells with the same gNB is fast backhaul and the scheduling of data transmitted in different cells for the UE can be easily coordinated in the same gNB. The backhaul connections may also be ones with longer latency and lower transmission rates.

FIG. 1B illustrates the use of carrier aggregation (CA), which is another deployment strategy. As shown in FIG. 1B, system 150 is a typical wireless network configured with carrier aggregation (CA) where communications controller 160 communicates to UE 120A using wireless link 170 (solid line) and to UE 120B using wireless link 172 (dashed line) and using wireless link 170, respectively. In some example deployments, for UE 120B, wireless link 170 can be called a primary component carrier (PCC) while wireless link 172 can be called a secondary component carrier (SCC). In some carrier aggregation deployments, the PCC can carry feedback from a UE device to a communications controller while the SCC can only carry data traffic. In the 3GPP specifications, a component carrier is called a cell. When multiple cells are controlled by a same eNB, cross scheduling of multiple cells can be implemented because there may be a single scheduler in the same eNB to schedule the multiple cells. With CA, one eNB may operate and control several component carriers forming primary cell (PCell) and secondary cell (SCell).

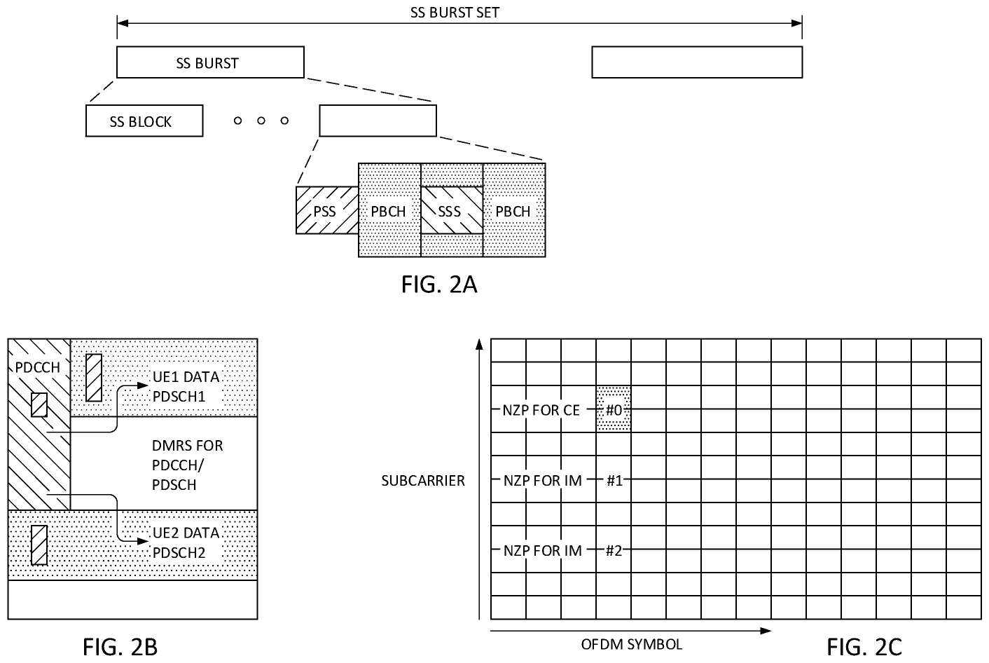

Physical layer channels and signals include primary synchronization signal (PSS)/secondary synchronization signal (SSS), PBCH (see, e.g., FIG. 2A, in which the SS bursts are embedded, i.e., multiplexed with PBCH around it), PDSCH and its associated demodulation reference signal (DMRS) and phase tracking reference signal (PT-RS), PDCCH and its associated DMRS (see, e.g., FIG. 2B for some of these signals/channels which are multiplexed for more than one UE), and channel state information reference signal (CSI-RS) which further include those used, for CSI acquisition, for beam management, and for tracking (see FIG. 2C for some examples of non-zero power (NZP) CSI-RS used for channel estimation (“CE”), interference measurement (“IM”), and so on, which are multiplexed with PDSCH and for one or more UEs). The CSI-RS for tracking is also called a tracking reference signal (TRS). Although not separately illustrated in FIG. 2A, PBCH may also be associated with a DMRS, in a similar manner to how the PDCCH of FIG. 2B has an associated DMRS.

The UE receives timing advance (TA) commands associated with the configured TA group (TAG) to adjust its uplink transmission timing to synchronize with the network for uplink transmission so that uplink transmissions from multiple UEs arrive at the base station at about the same time in a transmission time interval (TII), which is a slot in 5G NR. Likewise, the UE needs to receive DL reference signals (RS) or synchronization signal (SS) blocks, also called SS/physical broadcast channel (PBCH) block SS/PBCH block (SSB) to acquire and maintain the DL synchronization, such as via maintaining a DL timing tracking loop, based on which the UE places the start of its FFT window inside the cyclic prefix (CP) for its DL reception. In addition, both UL and DL signals/channels are to be associated with some other signals for deriving the signal/channel properties, such as delay spread, Doppler shift, etc.

In wireless communications operations, tracking functionalities performed by a UE may include fine time tracking, fine frequency tracking, delay spread estimation, and Doppler spread estimation.

In fine time tracking, a UE may detect the first arriving path, and based thereon, the UE may generally optimally place its Fast Fourier transform (FFT) window to maximize a data signal to noise plus inter-symbol interference ratio. In a continuous operation, a FFT window position may drift due to UE mobility and a residual oscillator error between a transmitter and a receiver. The UE may adjust its FFT window position based on a detected change of path arriving (or arrival) time.

In fine frequency tracking, a UE may detect a frequency offset between a transmitter and a receiver, and adjust its oscillator accordingly. A residual frequency error may be estimated and compensated in the demodulation of data symbols. The residual frequency error compensation may be very critical, especially in the case of high signal-to-noise ratio (SNR) and high code rate data transmissions. Uncompensated frequency error may impose phase error on modulated data symbols and result in decoding performance degradation. Because temperature change affects output precision of an oscillator and Doppler shift caused by UE movement, a UE may periodically track the frequency offset and apply corresponding adjustment and compensation.

Delay spread determines how dispersive a wireless multi-path channel that a UE experiences is. The longer the delay spread, the more frequency selective the channel is. To generally maximize processing gains along the frequency domain in channel estimation based on received pilot signals, the UE may apply linear filtering with a length as long as possible if within the coherent bandwidth of the channel. Coherent bandwidth is inversely proportion to channel selectiveness. Thus, delay spread estimation plays an important role in forming channel estimation filter coefficients and length, hence affecting the performance of channel estimation and data demodulation.

Doppler spread is usually proportional to UE movement speeds and multi-path spatial distribution. Larger Doppler spread corresponds to a faster changing wireless multi-path fading channel. Channel estimation usually applies filtering in the time domain with longer filter length to suppress noise plus interference if within the channel coherent time constraint. Doppler spread estimation is thus another factor along the time domain affecting UE channel estimation performance.

The quasi co-location (QCL) types corresponding to each DL RS (more specifically, the port(s) or antenna port(s) of the DL RS) are given by the higher layer parameter qcl-Type in QCL-Info and may take one of the following values: 1)‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial RX parameter}. The QCL types may be configured/indicated in transmission configuration indication (TCI) states for a RS. The QCL assumptions and TCI states are mainly used for DL RS, but can be generalized for UL RS if the association via pathloss RS and spatial relation are specified. The QCL assumption may be specified as: {RS1: QCL Type C to RS2}, {RS1: QCL Type C to RS2 and QCL Type D to RS3}. Then, RS1 (destination RS or target RS) derives the properties specified according to the QCL types from the associated (i.e., source or reference) RSs (e.g., RS2). Note that the source RS may be a SSB. Note also that the source RS and destination RS may be on the same carrier or different carriers (i.e., cross-carrier QCL). The QCL and TCI states can also be applied to cases where the target is not necessarily a signal, e.g., where the target is a channel (e.g., PUCCH, PUSCH, PDSCH, PDCCH) or a resource. Therefore, the general TCI state framework is that a (target) signal/channel/resource is configured with a TCI state, and the TCI state specifies a reference for the (target) signal/channel/resource and a relationship, the reference being a (source) signal, the relationship being a dependency/reliance specifying how the (target) signal/channel/resource relies on the reference.

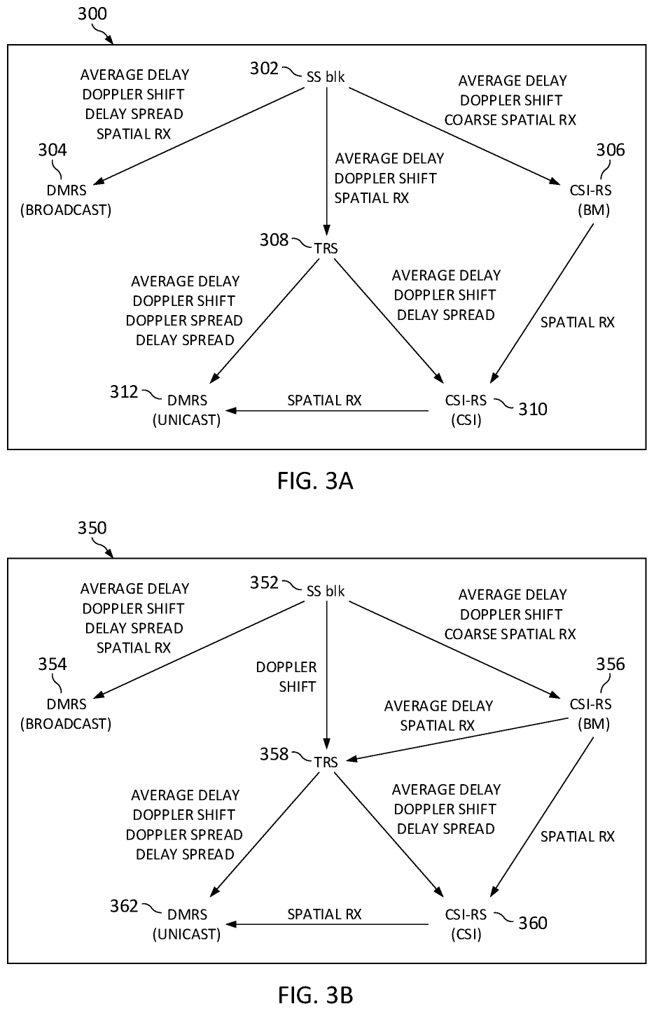

FIG. 3A is a diagram 300 showing QCL assumptions among NR reference signals when wide beams are used for communications. For example, a TRS, a SS block or a broadcast DMRS may be transmitted using a wide beam. FIG. 3A shows QCL configurations among a SS block 302, a DMRS 304, a CSI-RS 306, a TRS 308, a CSI-RS 310 and a DMRS 312. The DMRS 304 is for a broadcast channel. That is, the DMRS 304 is a DMRS used for demodulation of a system information block (SIB), radio resource control (RRC) signaling, paging, and etc. before a TRS is configured. The CSI-RS 306 is transmitted for beam forming. The CSI-RS 310 is transmitted for channel estimation. The DMRS 312 is used for demodulation of signals transmitted in a unicast channel. An arrow starting from a first reference signal (e.g., the SS block 302) and ending at a second reference signal (e.g., the DMRS 304) indicates that the second reference signal has a QCL relationship with the first reference signal with respect to one or more QCL parameters. The one or more QCL parameters (e.g., an average delay, a Doppler shift, a delay spread, and a spatial RX) are shown on the arrow, indicating that the one or more QCL parameters required by the second reference signal may be derived using the first reference signal.

As shown, the DMRS 304 is configured to have a QCL relationship with the SS block 302. The average delay, Doppler shift, delay spread, and spatial RX for the DMRS 304 may be derived based on the SS block 302. Similarly, the CSI-RS 306 and the TRS 308 has a QCL relationship with the SS block 302, respectively. An average delay, a Doppler shift, and a coarse spatial RX required by the CSI-RS 306 may be derived based on the SS block 302. An average delay, a Doppler shift, and a spatial RX required by the TRS 308 may be derived from the SS block 302. The CSI-RS 310 has a QCL relationship with the CSI-RS 306 and the TRS 308, respectively. The CSI-RS 310 may be received using a spatial RX derived based on the CSI-RS 306, and use an average delay, a Doppler shift, and a delay spread from the TRS 308. The DMRS 312 has a QCL relationship with the TRS 308 and the CSI-RS 310, respectively. The DMRS 312 may be received using a spatial RX derived based on the CSI-RS 310. The DMRS 312 may also be received an average delay, a Doppler shift, a Doppler spread and a delay spread derived based on the TRS 308.

FIG. 3B is a diagram 350 showing QCL assumptions among NR reference signals when narrow beams are used for communications. FIG. 3B shows QCL configurations among a SS block 352, a DMRS 354, a CSI-RS 356, a TRS 358, a CSI-RS 360 and a DMRS 362. Similar to FIG. 3A, the DMRS 354 is for demodulation of signals in a broadcast channel, e.g., a physical broadcast channel (PBCH), that is transmitted before a TRS is configured. The CSI-RS 356 is transmitted for beam forming. The CSI-RS 360 is transmitted for channel estimation. The DMRS 362 is used for demodulation of signals transmitted in a unicast channel. An arrow starting from a first reference signal and ending at a second reference signal indicates that the second reference signal has a QCL relationship with the first reference signal with respect to one or more QCL parameters. The one or more QCL parameters shown on the arrow indicate that the one or more QCL parameters required by the second reference signal may be derived using the first reference signal. FIG. 3B shows that the reference signals have QCL configurations similar to those illustrated in FIG. 3A, except for TRSs. In FIG. 3B, the TRS 358 has a QCL relationship with the SS block 352 and the CSI-RS 356, respectively. The TRS 358 may be received using a Doppler shift derived based on the SS block 352, and may be received using an average delay and a spatial RX derived based on the CSI-RS 356. Data transmission may employ multiple narrow beams, and multiple narrow TRS beams may be required for tracking. To support both of the scenarios, configuration of TRSs and their QCL assumptions or association should be flexible.

Sounding reference signals (SRSs) are reference signals transmitted by the user equipment (UE) in the uplink for the purpose of enabling uplink channel estimation over a certain bandwidth. As such, the network may be able to perform communication with the UEs based on the uplink channel estimation. Moreover, due to channel reciprocity between the uplink and the downlink present in a time division duplex (TDD) communication system, the network may utilize the SRSs to perform dynamic scheduling. That is, the network may exploit channel-dependent scheduling. In this case, the time-frequency resources are dynamically scheduled, taking into account the different traffic priorities and quality of services requirements. Typically, the UEs monitor several Physical Downlink Control Channels (PDCCHs) to acquire the scheduling decisions, which are signaled to the UEs by the network. Upon the detection of a valid PDCCH, the UE follows the scheduling decision and receives (or transmits) data.

The configuration of SRS related parameters of a SRS to be transmitted in the uplink (such as SRS transmission ports, SRS transmission bandwidth, SRS resources sets, transmission comb and cyclic shift, etc.) are semi-static in nature and may be provided through higher layer signaling, such as radio resource control signaling. Moreover, the association between the downlink reference signals, such as Channel State Information Reference Signals (CSI-RS) or demodulation reference signals (DMRS), and the uplink SRS should be conveyed to the UE to accurately reflect the interference situation and perform optimal beamforming. Thus, there is a need for apparatus and methods for signaling control information that accurately indicates a more dynamic configuration (not semi-static) of the aforementioned parameters, such as, for example, a portion of the transmission bandwidth required to transmit a subset of the SRS resource set (thereby implicitly indicating a transmission comb and cyclic shift) using a subset of the transmission ports associated with a particular set of downlink reference signals. The signaling of the control information may be closely tied to an actual data transmission. The transmission of the SRS may be periodic (i.e., periodic SRS, P-SRS or P SRS) as configured by Layer 3 RRC configuration signaling, semi-persistence (i.e., semi-persistent SRS, SP-SRS or SP SRS) activated/deactivated via Layer 2 MAC CE, or aperiodic (i.e., aperiodic SRS, A-SRS or AP-SRS or A SRS or AP SRS) indicated by Layer 1 DCI in PDCCH.

Network adaptation, or adaptive transmission, such as cell on/off, fast SCell activation/deactivation, SCell layer-1 dormancy, etc., has been studied in 3GPP to achieve efficient network adaptation for various purposes, such as network/UE power saving, interference management, network/UE complexity reduction, and so on.

The higher power consumption of 5G NR, specifically by the gNB, is multiple times greater than LTE base stations. Some reasons include the larger number of transmit/receive channels, larger bandwidth, and greater transmission power of 5G NR. For example, 5G NR uses a large number of antennas (where each antenna may include a high-resolution AD/DA), uses a wide bandwidth, and has dense deployment, all of which contribute to high power consumption.

Embodiments include techniques for power savings in 5G NR. A first objective is to achieve more efficient operation dynamically and/or semi-statically and achieve finer granularity adaptation of transmissions/receptions. Network energy saving techniques may be in the time, frequency, spatial, and/or power domains. Some embodiments include support (e.g., feedback) from a UE 120 to a base station 110 (e.g., a gNB), including receiving assistance information from the UE 120. A second objective is to accommodate information exchange and coordination over network interfaces. Embodiment power savings techniques may be advantageous over power savings techniques (such as simply turning off some components when there is no traffic associated with them).

Embodiment power savings techniques may perform network adaptation in spatial, time, and/or frequency domains. Granularity of the adaptation may be at the macro level or at the micro level. Macro and micro level adaptations may be referred to as coarse and fine adaptations, respectively.

Coarse level adaption includes dynamic adaptation of a transmit/receive (TRX) port, panel, and/or beam, thus taking advantage of spatial diversity. For example, TRX ports may be switched on/off. By switching off some of the TRX ports, at least for a low or medium network load, energy consumption can be reduced since the number of associated circuitries are reduced. To enable such coarse level adaptation, CSI-RS reporting may be used to assist the network (e.g., a base station no) in deciding which and when to dynamically turn on/off the port, panel, and/or beam. Therefore, some embodiments support further enhancements in CSI-RS measurements and reporting to enable dynamic and macro level adaptation.

Fine level adaption includes dynamic adaptation in either time, frequency, and/or spatial domains. For example, time domain adaptation may be performed, in which a symbol, subframe, or frame is dynamically switched on/off. Time domain adaptation may be performed with a time scale that is on the order of a symbol, subframe, or frame. Time domain adaptation may, at least for a low or medium network load, reduce energy consumption with minimal impact on users and system throughput.

Time domain adaptation may be beneficial for some channels. Channels where time domain adaptation approaches may be beneficial include broadcast and common channels such as the SSB and system information (SI) messages and paging signals/channels; PDCCH and PDSCH in the DL; and physical signals/reference signals such as the TRS, PRACH, and SRS. As an example, the current system design of SSB and SIB1 uses always ON transmissions designed to allow a UE 120 immediate access to a network with minimal latency. Using longer periodicities for these always-on signals may result in less transmission power since less beam activity would be used for the transmissions and reception of these signals. Some embodiments provide for adaptive (or aperiodic) and dynamic (e.g., on-demand) adjustment of periodicities such as aperiodic transmission of SSB based on the current network needs at the moment, e.g., UE 120 traffic or distribution. Configurable transmissions, e.g., semi-persistent scheduled (SPS) PDSCH, periodical TRS/CSI-RS/SRS, semi-persistent CSI-RS/SRS, etc., can be associated with time domain adaptation, such as by activation/deactivation of a PDSCH configuration, activation/deactivation or changing of periodicity of a SPS PDSCH configuration, activation/deactivation or changing of periodicity of a periodic/semi-persistent (P/SP) CSI-RS configuration, etc. Likewise, UL channels such as PUSCH/PUCCH can be associated with time domain adaptation, such as by activation/deactivation of a PUSCH configuration, activation/deactivation or changing of periodicity of a configured grant (CG) PUSCH configuration, etc.

To address concerns that time domain adaptation would result in negative impact, embodiment techniques may offset potential negative impact such as reduced user perceived throughput, call drop rate, increased cell access latency, etc. Time domain approaches including but not limited to longer and dynamic adaption of periodicities of common and broadcast may be utilized.

In the frequency domain, multicarrier or BWPs adaptation as in LTE turning on/off of small cell since Release 12 are supported. A network-based approach to dynamically adapt and adjust transmission and reception bandwidths is supported through the introduction of UE signaling and measurements to support these adaptations.

According to various embodiments, components of a network (e.g., base station(s) 110) will be configured to operate in different power states. A base station 110 may transition between different power states, and signal such transitions to UEs 120. In some embodiments, a base station 110 may operate in three different basic sleep states: deep sleep, light sleep, and micro sleep. The transition energy and total transition time for the three sleep types may be predetermined, such as in a standards specification. It should be appreciated there may be additional states. For example, as subsequently described, the power states may include states for PDCCH-only, SSB or CSI-RS processing, PDCCH and PDSCH, and UL.

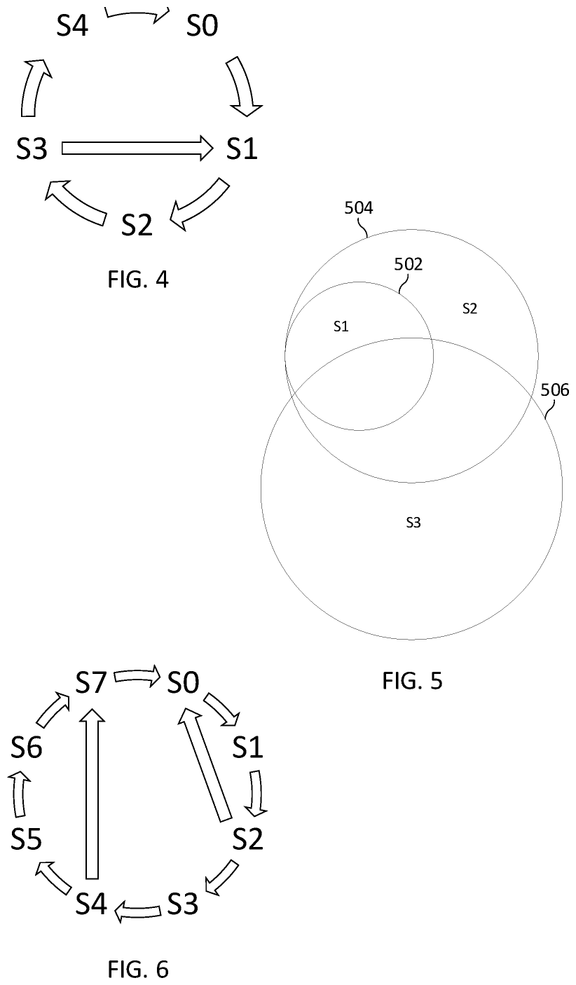

FIG. 4 is a power consumption model for a base station 110, according to some embodiments. The power consumption model is a state diagram having five power states. Each state may be transitioned to from a previous state, or from another state.

State 0 (S0) represents the base station 110 being completely off. Specifically, S0 represents a shutdown scenario where all transmit, receive, and backhaul (BH) features are turned off.

State 1 (S1) is a deep sleep state. In this state, transmission and reception are turned off. The base station 110 monitors the BH for a trigger, and transitions to the next state (e.g., turns components on) in response to receiving the trigger.

State 2 (S2) is a light sleep state. In this state, transmission is turned off. The base station no monitors UL for a wake-up signal (WUS) and/or monitors the BH for a trigger, and transitions to the next state (e.g., turns components on) in response to receiving the WUS or trigger.

State 3 (S3) is a light non-sleep state. In this state, only the random access channel (RACH) is turned on for reception. Additionally, transmission is turned off. The base station 110 monitors the RACH for a trigger, and transitions to the next state (e.g., turns components on) in response to receiving the trigger.

State 4 (S4) is a full non-sleep state that represents the base station 110 being completely on. In this state, all transmit, receive, and backhaul (BH) features are turned on.

S0-S4 are examples of base station 110 activity levels/activation levels/power states and their characteristics/descriptions. Additionally, although the power consumption model is described for a base station 110, it could be applied to any network equipment, such as a RRH, IAB node, relay, transmit/receive point (TRP), transmit point (TP), receive point (RP), antenna unit, part of an antenna unit, etc. Additionally, the transitions between some states are shown for illustrative purposes. Specifically, FIG. 4 illustrates states S0-S4 and the arrows show some transitions between two states (e.g., S2 to S0). Additionally, FIG. 4 illustrates a transition between two arbitrary states (e.g., S3 to S1) for illustrative purposes. Theoretically, a transition is possible from any state to any other state (or state combination). The states and conditions for state transitions may be predetermined, such as in a standards specification.

At least some of the power states of the power consumption model can optionally correspond to fine and coarse power adaptation, e.g., Deep and Light Sleep states, respectively. It should be appreciated that additional states could also be utilized. For example, a micro sleep state may be utilized, in which more TX/RX features are enabled than in deep/light sleep states, which allows for a quick transition to an active state. These states may be predetermined, such as in a standards specification for a base station 110 or in a RRC configuration signaled to the UEs 120. S0 and S4 correspond to legacy base station power consumption operation. If only these two states were present, then the power consumption model would correspond to a scenario lacking fine or coarse adaptation of the base station transmit power. S1 corresponds to power adaptation that is activated and/or deactivated through a backhaul such as in the form UE 120 assistance data that is signaled through the backhaul. No air-interface or layer 1 monitoring may be utilized in S1 since both the transmit and receive processing of base stations 110 have been turned off. In S2, layer 1 receive monitoring is still operational and only the transmission chain has been turned off. S1 and S2 are states providing fine and coarse power adaptation, respectively.

The various power states are associated with activity levels of network resources. For example, the air-interface resources are grouped into sets, and each set of air-interface resources is associated with one or more power states. A base station 110 operating in a given power state utilizes the air-interface resources from the sets associated with that power state. The groupings/associations may be predetermined, such as in a standards specification or a RRC configuration. The sets of air-interface resources associated with the power states may overlap or may include different resources.

FIG. 5 is a Venn diagram of air-interface resources for power states, according to some embodiments. The air-interface resources associated with S1, S2, and S3 (see FIG. 4) are illustrated as an example. In this embodiment, S1 (e.g., a low-energy state) is associated with first air-interface resources 502, S2 (e.g., a medium-energy state) is associated with second air-interface resources 504, and S3 (e.g., a high-energy state) is associated with third air-interface resources 506, where the second air-interface resources 504 is a superset of the first air-interface resources 502, and where the third air-interface resources 506 includes a subset of the second air-interface resources 504 and a subset of the first air-interface resources 502. For example: S1 may be associated with a first set of air-interface resources; S2 may be associated with the first set of air-interface resources and a second set of air-interface resources; and S3 may be associated with the second set of air-interface resources, a third set of air-interface resources, and a fourth set of air-interface resources, but not the first set of air-interface resources. It is also possible for the third air-interface resources 506 to include all of the other air-interface resources 502, 504.

FIG. 6 is a power consumption model for a base station 110, according to some other embodiments. This embodiment is similar to the embodiment of FIG. 4, except the power consumption model has eight power states.

State 0 (S0) represents the base station 110 being completely off. Specifically, S0 represents a shutdown scenario where all transmit, receive, and backhaul (BH) features are turned off. Therefore, the base station 110 cannot be utilized. A timer may be used to wake up the base station 110. In S0, the relative power level is zero, e.g., the base station 110 consumes substantially no power.

State 1 (S1) is a deep sleep state. In this state, transmission and reception are turned off. The base station 110 turns its connection to other network equipment on, which does not consume much power, but keeps its most power-consuming components off. The base station 110 monitors the BH for a trigger, and transitions to the next state (e.g., turns components on) in response to receiving the trigger. When the base station 110 needs to serve UEs 120 as determined by a network controller (e.g., a coordination center), it receives a signaling/message from the network controller and then powers up the components of the base station 110 based on the signaling, such as the receive components (thus entering S2 or S3 or S4) or the transmit and receive components (thus entering S5). The power up process takes time, such as due to requiring a state transition with a transient time. During the transient time, the base station 110 may not be able to serve UEs 120, and the transient time may be as long as a few seconds to minutes.

State 2 (S2) is a light sleep state. In this state, transmission is turned off. The base station 110 monitors UL for a wake-up signal (WUS) and/or monitors the BH for a trigger, and transitions to the next state (e.g., turns components on) in response to receiving the WUS or trigger. In S2 the relative power level is approximately ten times that of S1.

State 3 (S3) is a light non-sleep state. In this state, only the random access channel (RACH) is turned on for reception. Additionally, transmission is turned off. The base station 110 monitors the RACH for a trigger, and transitions to the next state (e.g., turns components on) in response to receiving the trigger. For example, PRACH preambles may be monitored on a RACH Occasion (RO). In S3 the relative power level is approximately 100 times that of S1.

State 4 (S4) is a light non-sleep state. In this state, all reception is turned on. In S4 the relative power level is approximately 1000 times that of S1.

In S2, S3, and S4, the base station 110 still has transmission components turned off. Transmission components may be more power consuming than reception components. Thus, the base station 110 is in a “listen-only” mode in S2, S3, and S4. The base station 110 saves power in “listen-only” mode by only turning on limited RF components for UL WUS monitoring. For example, in S2, the UL WUS (e.g., a narrowband waveform signal) may be sent from UEs 120 to let the base station 110 know it is in proximity. In S3, the base station 110 can monitor PRACH preambles on pre-configured RACH opportunities (ROs), which consumes more power. In S4, the base station 110 can receive any UL signals/channels but does not transmit.

State 5 (S5) is a light non-sleep state. In this state, basic transmission is turned on, but no carrier aggregation or higher order (e.g., MIMO) operations are performed. In S5 the relative power level is approximately 10000 times that of S1.

State 6 (S6) is a light non-sleep state. In this state, basic transmission and higher order operations (e.g., MIMO) are turned on, but only some carriers may be used. For example, n carriers may be used for transmission/reception, where n is less than the total number of available carriers. In S6 the relative power level is approximately 10000*n times that of S1.

State 7 (S7) is a full non-sleep state that represents the base station 110 being completely on. In this state, all transmit, receive, and backhaul (BH) features are turned on. For example, m carriers may be used for transmission/reception, where m is greater than the n carriers used in S6. In S7 the relative power level is approximately 10000*m times that of S1.

In S5, S6, and S7, the base station 110 turns on some or all of its transmission components. S5 has basic transmission components on, but the base station 110 does not operate advanced features such as carrier aggregation or higher order (e.g., MIMO) operations. For example, the base station 110 may only operate one carrier and one (or a small number of) transmit/receive unit(s). S6 has high-order MIMO supported, so n transmit/receive units may be in use (out of N total transmit/receive units, where 1<n<=N). S7 has CA supported, so m carriers may be in use (out of M total transmit/receive units, where 1<m<=M).

Some of the previously described states may be combined. For example, S6 and S7 can be a valid base station 110 operating condition if the base station 110 has dedicated components for MIMO and CA, although for some base stations, some components may be shared by MIMO and CA, so if high-order MIMO is used, the number of carriers that the base stations 110 can support will be smaller than the case when high-order MIMO is not activated. In general, there could be more states than previously described, and there could be combinations of different states.

To be more compatible with existing standards, a default state may be utilized. A default state is the state of operations according to a legacy standard. For example, for SCells, upon configuration they are generally in a deactivation state unless or until a signaling informs UEs 120 otherwise. This extends to future standards releases. For example, upon configuration of a resource, the default state of a resource may be deactivated/inactive if no explicit indication of the state is provided.

In some embodiments, the network configures a number of states for one or more UEs 120. Each state (or mode, e.g., sleep mode) is assigned with a unique identifier (e.g., ID, name, index, indicator, etc.). The operations that the UE 120 can expect or assume about the base station 110 are also provided by configuration signaling. Examples of such operations include whether PRACH is allowed on some ROs, or n transmit/receive units are on, or some PRACH resources are activated, or some SSB/CSI-RS/SRS are activated, etc. In general, which base station resources/UE-configured resources are activated or deactivated (e.g., used/not used, or turn on/off) for a state are configured for the UE 120. Some embodiments of the UE-configured resources will be subsequently described in greater detail. After the configuration, the identifier may be carried in a signaling to one or more UEs 120 to inform the UEs 120 about the state the base station 110 is currently in or about to enter. Some embodiments of the signaling will be subsequently described in greater detail.

S0-S7 are examples of base station 110 activity levels/activation levels/power states and their characteristics/descriptions. Other levels can be included, and some levers can be removed. Similarly, the capabilities at each level can include any combination of capabilities (limited or otherwise) described herein. Although the power consumption model is described for a base station 110, it could be applied to any network equipment, such as a RRH, IAB node, relay, transmit/receive point (TRP), transmit point (TP), receive point (RP), antenna units, part of an antenna unit, etc. Additionally, the transitions between some states is shown for illustrative purposes. Specifically, FIG. 6 illustrates states S0-S7 and the arrows show some transitions between two states (e.g., S2 to S0 and S4 to S7). Theoretically, a transition is possible from any state to any other state (or state combination). To reduce complexity, only a subset of states or state transitions may be supported. For example, a standard may specify that, from S1, the only possible transition is to S2 and not to others.

Three parameters may be relevant to the state transitions of FIGS. 4 and 6. For example, for a transition from S0 to S1, Δt₀₁ is the transition time during which the base station 110 (and hence the associated UEs 120 or equipment connected via backhaul) may experience interruption. Similarly, for a transition from S0 to S1, ΔE₀₁ is the energy the base station 110 takes for the transition. To prevent frequent transitions which may cause frequent interruptions and equipment issues, t_{min dwell} may be associated with a state or a state transition, i.e., the base station 110 may be configured to stay in a state for a minimum dwell time of t_{min dwell}. Generally speaking, the dwell time is longer if the transition time is longer and/or the transition energy is higher.

In some embodiments, some parameters related to the state transition or the state of a base station 110 are signaled to a UE 120. For example, for a transition from a state i to a state j, the transition time Δtᵢⱼ may be signaled to the UE 120 so that the UE 120 knows an interruption is expected when transitioning from state i to state j, and the UE 120 does not expect to receive/transmit signals/channels during that duration. The minimum dwell time t_{min dwell,i} for state i may be signaled to the UE 120 so that the UE 120 does not expect any transition once the base station 110 enters the associated state, such as not expecting a state transition command from the base station 110 before the end of the minimum dwell time.

In some embodiments, some parameters related to the state transition or the state of a base station 110 are signaled to other network nodes. For example, for a transition from a state i to a state j, the transition time Δtᵢⱼ may be signaled to a network coordinator (or a cooperating node) so that the network coordinator knows the interruption duration when the base station 110 transitions from state i to state j, and it can take into account the time for making a transition decision related to the base station 110. The minimum dwell time t_{min dwell,i} for state i may be signaled to the network coordinator so that network coordinator does not make any transition decision once the base station 110 enters the associated state. The transition energy ΔEᵢⱼ for a transition from a state i to a state j may be signaled to the network coordinator so that network coordinator knows the energy cost when the base station 110 transitions from state i to state j, and it can take into account of the cost of making a transition decision related to the base station 110. In some embodiments, a subset of allowed transitions for a base station no may be signaled between the base station no and another network node.

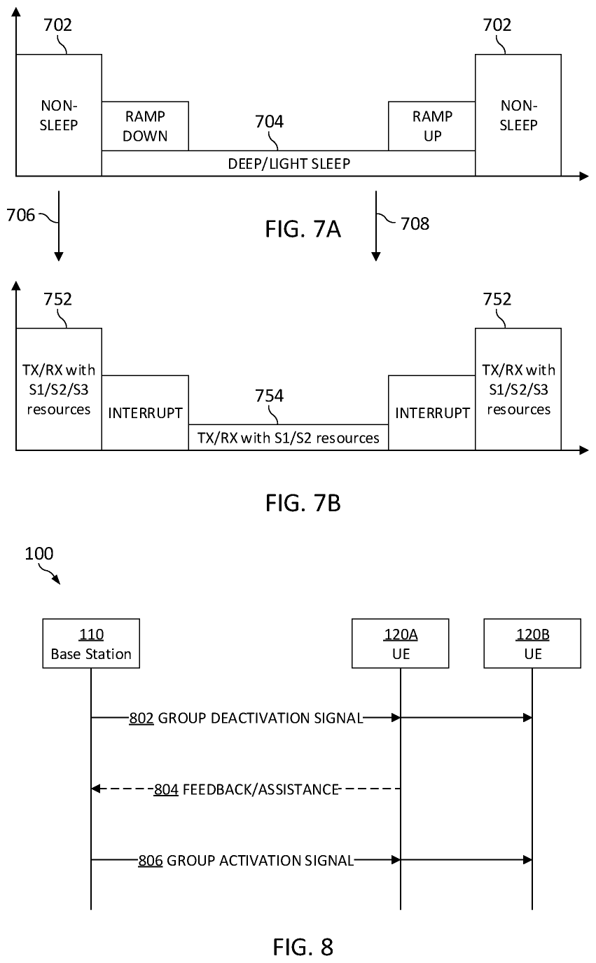

FIG. 7A illustrates relative power consumption of a base station no at various states, according to some embodiments. FIG. 7B illustrates relative activity of a UE 120 at the states of FIG. 7A, according to some embodiments.

In non-sleep states 702 (including, e.g., S5, S6, and S7 of FIG. 6) the base station no has a greater power consumption than in sleep states 704 (including, e.g., S1, S2, S3, and S4 of FIG. 6). Although not separately illustrated, the base station no may have a greater power consumption in a light sleep state (e.g., S2 of FIG. 6) than in a deep sleep state (e.g., S1 of FIG. 6). When transitioning from a non-sleep state 702 to a sleep state 704 (or vice versa), the base station no has a power consumption between that of the non-sleep state 702 and the sleep state 704. The transition period may be a ramp-down or ramp-up period having a transition time. The transition time and transition energy may be predetermined, such as in a standards specification or according to a RRC configuration. Before a ramp-down transition, the base station 110 sends a deactivation signaling 706 to a group of UEs affected by the transition, including the UE 120. Before a ramp-up transition, the base station 110 sends an activation signaling 708 to a group of UEs affected by the transition, including the UE 120.

When the base station 110 is in a non-sleep state 702, the UE 120 is in a higher-performance state 752. In the higher-performance state 752, the UE 120 communicates (e.g., transmits/receives) with sets of air-interface resources associated with the higher-performance state 752. For example, in the higher-performance state 752, the UE 120 may communicate with a first, second, and third set of air-interface resources associated with the higher-performance state 752. When the base station 110 is in a sleep state 704, the UE 120 is in a higher-efficiency state 754. In the higher-efficiency state 754, the UE 120 communicates (e.g., transmits/receives) with sets of air-interface resources associated with the higher-efficiency state 754. Communication performance in the higher-efficiency state 754 may be lower than in the higher-performance state 752. The sets of air-interface resources associated with the higher-efficiency state 754 are different than the sets of air-interface resources associated with the higher-performance state 752. For example, in the higher-efficiency state 754, the UE 120 may communicate with the first and/or second set of air-interface resources, but not the third set of air-interface resources. When transitioning from a higher-performance state 752 to a higher-efficiency state 754 (or vice versa), the UE 120 has a period of interruption in service. The interruption period may be predetermined, such as in a standards specification or according to a RRC configuration. The UE knows the start timing and the duration of the interruption based on the deactivation signaling 706 from the base station 110, and the UE is expected not to receive a signal/channel from or transmit a signal/channel to the base station 110 during the interruption. Similarly, the UE knows the start timing and the duration of the interruption based on the activation signaling 708 from the base station 110, and the UE is expected not to receive a signal/channel from or transmit a signal/channel to the base station 110 during the interruption.

FIG. 8 is a protocol diagram of operations in a wireless communication system 100 during state transitions, according to some embodiments. Specifically, signaling during the transitions between the states of in FIGS. 7A and 7B is illustrated.

In step 802, a base station 110 sends first transition signaling to multiple UEs 120 (including a UE 120A and a UE 120B). Transition signaling will be subsequently described in greater detail. In this example, the first transition signaling is a group deactivation signal for transitioning the base station 110 from a non-sleep state 702 to a sleep state 704 (see FIG. 7A), or more generally from a higher-performance state to a higher-efficiency state. Accordingly, the UEs 120 transition from a higher-performance state 752 to a higher-efficiency state 754 (see FIG. 7B). The group deactivation signal implicitly or explicitly indicates the current or next state of the base station 110 to the UEs 120. The group deactivation signal may also trigger the transmission of signals/channels that facilitate the state transition. Examples of such signals/channels include a TRS, CSI-RS, SRS/PRACH, MAC CE, RRC for a group of UEs 120, and the like. The UEs 120 may have previously defined behaviors corresponding to the first transition signaling and the triggered signals/channels. Examples of such behaviors include QCL assumptions, time/frequency (T/F) synchronization, automatic gain control (AGC), channel state information (CSI) measurement and reporting, and the like.

Triggering the transmission of signals/channels that facilitate the state transition to the UEs 120 allows network resources in any possible domain to be used without revealing the internal structure/implementation/algorithm of the network, which may be desirable for operators of base stations 110. The adaptable network components may be pre-packaged via RRC configuration signaling into air-interface resource groups for any purposes, such as network energy saving (NES), adaptation, etc. Utilizing group signaling may reduce overhead and latency, allowing for finer granularity of adaption. Dynamic on/off or adaptation of internal network components may thus be efficiently conveyed over an air interface.

In step 804, optionally, one or more of the UEs 120 (e.g., the UE 120A) may transmit feedback and assistance information to the base station 110. The feedback and assistance information may be part of a feedback and assistance information report. The feedback and assistance information report will be subsequently described in greater detail. Examples of feedback and assistance information include an uplink wake up signal, SRS/PRACH, CSI/RSRP report, UE experience metric, UE traffic, UE location, UE preference configuration, and the like. The base station 110 may use the feedback and assistance information to assist with, trigger, or request a state transition. Accordingly, a UE 120 may implicitly or explicitly request a state transition.

In step 806, the base station 110 sends second transition signaling to the UEs 120 (including the UE 120A and the UE 120B). Transition signaling will be subsequently described in greater detail. In this example, the second transition signaling is a group activation signal for transitioning the base station 110 from a sleep state 704 to a non-sleep state 702 (see FIG. 7A). Accordingly, the UEs 120 transition from a higher-efficiency state 754 to a higher-performance state 752 (see FIG. 7B). The group activation signal implicitly or explicitly indicates the current or next state of the base station 110 to the UEs 120, in a similar manner as the group deactivation signal. The group activation signal may also trigger the transmission of signals/channels that facilitate the state transition, in a similar manner as the group deactivation signal. The UEs 120 may have previously defined behaviors corresponding to the second transition signaling and the triggered signals/channels, in a similar manner as the first transition signaling.

In some embodiments, the transition signaling (for the group activation/deactivation signals) is group signaling. The group signaling may be cell-level or carrier-level signaling. Using cell-level or carrier-level activation/deactivation signaling, as opposed to UE-specific activation/deactivation signaling, may enable a group of cells (or carriers) with shared power amplifier carriers to have fast on/off signaling and the ability to turn on/off at a pre-configured schedule triggered by the signaling. This may be advantageous in networks with CA and with overlapping coverage per layer/carrier. In some embodiments, frequency domain adaptation includes the adaptation of multi-carriers and/or BWPs at the cell level using cell-level activation/deactivation signaling. This also includes group-level activation/deactivation signaling. In some embodiments, the network controller transmits a signaling/control message to a group of UEs. A broadcast control signaling/message may be used. In other embodiments, a dedicated signaling/message is sent to each UE 120.

As previously noted, the base station 110 sends transition signaling to the UEs 120 to indicate group activation/deactivation. The transition signaling deactivates (or activates) a set of resources for the group of the UEs 120. Specifically, the transition signaling is signaling to a group of UEs 120, and indicates the status of a set of resources for the group of UEs 120. Embodiments for the set of resources will be subsequently described.

In some embodiments, the set of resources corresponds to all the resources configured for each of a group of UEs 120 in a SCell that is common to all the UEs 120 in the group. For example, a first cell/carrier may be configured as a SCell for a first UE 120, a second UE 120, and a third UE 120. When the hardware for the first cell is to be turned off (or is entering a mode that does not transmit or receive air interface transmissions), the network can send a group signaling to the first UE 120, the second UE 120, and the third UE 120 to deactivate the first cell for the UEs 120. All resources configured for each of the UEs 120 associated with the first cell will be deactivated, including all physical signals in all UL BWPs and all DL BWPs of the first cell, all physical channels in all UL BWPs and all DL BWPs of the first cell, and all monitoring/processing operations by the UEs 120 for the first cell, except some long-periodicity SSB/DL RS processing may be performed to maintain RRM measurement.

In some embodiments, the set of resources corresponds to all the resources configured for each of a group of UEs 120 in multiple SCells common to all the UEs 120 in the group. For example, a first cell/carrier and a second cell/carrier may be configured as SCells for a first UE 120, a second UE 120, and a third UE 120. When the hardware for the first cell and the second cell is to be turned off (or is entering a mode that does not transmit or receive air interface transmissions), the network can send a group signaling to the first UE 120, the second UE 120, and the third UE 120 to deactivate the first cell and the second cell for the UEs 120. This may be advantageous when the first cell and the second cell are on the same band and share at least some common RF/baseband processing hardware and the signaling can be sent to multiple UEs regarding the status of multiple cells, which can reduce signaling overhead and complexity compared to sending to individual UEs regarding individual cells via dedicated signaling.

In some embodiments, the set of resources corresponds to all the resources configured for each of a group of UEs 120 associated with a same DL signal. The same DL signal may be a SSB with an index; a CSI-RS resource, resource set, or resource setting; a TRS; or the like. The DL signal may be associated with a beam, which is enabled by a subset of RF components, such as a subset of antenna panels of a base station 110, a subset of PAs of a base station 110, etc. For example, the first cell may include two beams (e.g., SSB 0 and SSB 1), where SSB 1 is configured for the first UE 120, the second UE 120, and the third UE 120. When the hardware for SSB 1 is to be turned off (or is entering a mode that does not transmit or receive air interface transmissions), the network can send a group signaling to the first UE 120, the second UE 120, and the third UE 120 to deactivate SSB 1 for the UEs 120. When SSB 1 is deactivated, all signals, channels, resources, and/or operations relying on SSB 1 are also deactivated, such as all the CSI-RS, TRS, PDCCH, and/or PDSCH that are QCLed to SSB 1 directly or via another signal. The reliance of a target signal, channel, or resource on a source or reference signal may be according to the TCI state (previously described). Additionally, the SRS, PUCCH, and/or PUSCH that rely on SSB 1 as path loss RS, RS of the spatial relation info, or rely on a DL RS which is QCLed to SSB 1 may be deactivated. For another example, the first cell may include two TRSs (e.g., TRS 0 and TRS 1), where TRS 1 is configured for the first UE 120, the second UE 120, and the third UE 120. When the hardware for TRS 1 is to be turned off (or is entering a mode that does not transmit or receive air interface transmissions), the network can send a group signaling to the first UE 120, the second UE 120, and the third UE 120 to deactivate TRS 1 for the UEs 120. When TRS 1 is deactivated, all signals, channels, resources, and/or operations relying on TRS 1 are also deactivated.

Other embodiments for the set of resources to be activated may include an initial BWP for a carrier, a common “cell specific” BWP configured via BWP-DownlinkCommon and BWP-UplinkCommon, a CORESET on a carrier (e.g., CORESET 0), PDCCH with pdcch-ConfigCommon, PDSCH with pdsch-ConfigCommon, a TCI state commonly configured for a set of UEs 120, other time/frequency resources and signals/channels commonly configured for a set of UEs 120, and the like. Such resources may be configured in a “cell specific” information element (IE), such as with the term “common”, such as BWP-DownlinkCommon and RACH-ConfigCommon. Other resources not configured as “cell specific” or “common” can still work as long as their parameters are aligned across a group of UEs 120. Some configurations, parameters, relationships, or resources may be for a set of cells/carriers/TRPs, and they may also be included in a RRC information element (IE), MAC CE, or DCI. That is, the set of resources to be activated may be associated with a multi-cell/multi-carrier/multi-TRP RRC IE, MAC CE, or DCI. When a resource is deactivated, all signals, channels, resources, and/or operations relying on that resource are also deactivated. The signals, channels, resources relying on the resource may be configured within the set of resources. When a group common activation signaling is sent to the group of UEs 120 to activate a set of resource (for example, downlink/uplink BWP, a cell/carrier, etc.), it indicates that the resources are to be activated for use from the perspective of the base station 110. For the UEs 120 receiving the group activation signaling, to utilize the resource or activate the resource for usage, another UE-specific activation signaling may be additionally used. To speed up the activation process for a UE to use the activated resource, the resource may be activated for the UE after the group signaling without a UE-specific activation signaling. Whether a UE-specific activation signaling is used after group activation signaling for a UE may be configured by RRC signaling or via a UE capability signaling.

As previously noted, the base station 110 may send transition signaling to the UEs 120 with group signaling. In some embodiments, one or more UEs 120 configured with a set of resources may receive the group signaling. In some embodiments, one or more UEs 120 pre-configured with a certain group identifier by RRC configuration signaling receive the group signaling. The group identifier may be a group Radio Network Temporary Identifier (RNTI) for a group common DCI (GC-DCI); an ID included in a DCI, a MAC CE, or a RRC signaling; or the like. Embodiments for the communication of the group signaling will be subsequently described.

In some embodiments, the group signaling is or includes a GC-DCI. In a specific embodiment, the GC-DCI is an enhanced format of the current DCI format 2-6. The enhanced DCI format may have CRC scrambled by a group RNTI, such as a certain power saving RNTI. All of the UEs 120 configured with the RNTI will monitor and decode the DCI format. The DCI format include multiple blocks, where each block is for a UE 120, and the starting position of a block is determined by a parameter provided by RRC higher layers for the UE 120 configured with the block. If a UE 120 is configured with the RNTI, it is also configured with one or more blocks via RRC higher layer parameters, and each block may include one or more fields. Each field may be associated with a set of resources, and multiple fields are then associated with multiple sets of resources. For each field, one or more bits are used to convey the status of the set of resources associated with the field. If the set of resources is assigned with only activation/deactivation states, then one bit may be utilized, but if k different states are assigned, then the quantity of bits needed for the field may be expressed as the smallest integer greater than or equal to the log base 2 of k. One particular example is that a field is for a SCell group of the UE 120, and the field is the SCell dormancy indication field, which may be used to inform the UE 120 of the status of the SCell group as “dormant” or “non-dormant” with one bit.

In some embodiments, the group signaling is a GC-DCI scheduling a group MAC CE or a RRC signaling.

In some embodiments, the group signaling is a GC-DCI scheduling a group RRC signaling.

As previously noted, the transition signaling sent by the base station 110 indicates the status of the set of resources for the group of UEs 120. The status may be indicated implicitly or explicitly to the UEs 120. For example, the status may explicitly indicate particular resources are fully deactivated or activated. Similarly, the status may indicate the base station 110 is (or will be) entering a particular state or activity level, which implicitly indicates which resources are deactivated or activated. Embodiments for how the status is indicated will be subsequently described.

In some embodiments, the transition signaling indicates the status of the set of resources by indicating the set of resources are fully deactivated in both UL and DL. All signals, channels, and/or operations are deactivated accordingly.

In some embodiments, the transition signaling indicates the status of the set of resources by indicating the set of resources are deactivated in only UL or only DL. All associated UL or DL signals, channels, and/or operations are deactivated accordingly.

In some embodiments, the transition signaling indicates the status of the set of resources by indicating the set of resources are to be operated with an increased or with a reduced activity level/activation level. The activity levels/activation levels may, for example, be any of the levels previously described for FIGS. 4 and 6.

In some embodiments, the transition signaling indicates the status of the set of resources by indicating resources of the set of resources are to adjust their periodicities. For example, a periodic signal such as SSB r periodic TRS may be associated with several periodicities. Longer periodicities are for less active states and shorter periodicities are for more active states. The transition signaling may indicate which periodicity should be used.

The contents of the transition signaling may be in any suitable format to accomplish the previously described functionality. In some embodiments, the group signaling includes (e.g., carries) an explicit indicator of the activity level/activation level that the set of network resources will be operating on. The explicit indicator may be based on a pre-configured list of activity levels, such as from a standards specification. For example, an indicator of 0 or 1 may be used to indicate resource deactivation or activation. Similarly, an indicator of 0, 1, 2, or 3 may be used to indicate resource activity level/activation level 0, 1, 2, or 3, thereby implicitly indicating the value for a resource. Likewise, a value explicitly indicating the value for a resource (e.g., transmission power level, periodicity of a RS, etc.) of the network may be used. The previously described GC-DCI embodiments are some examples. In some embodiments, the group signaling includes (e.g., carries) an indicator that an activity level should be increased or decreased by a desired increment, such as an activity level change indication of −1, +1, −2, etc. In some embodiments, the group signaling includes (e.g., carries) information (or values) for a set of parameters that the set of network resources will be operating on or the group of UEs 120 will expect or assume. For example, the set of parameters may include timing for the new activity level/activation level, the minimum duration that the network resources will be on the new activity level/activation level, a bitmap of resources identifiers to be activated/deactivated, a list of resources identifiers to be activated/deactivated/received aperiodically, a transmission power level, a periodicity of a resource, and the like. The parameters are signaled to the UEs 120 separately, before the values for the parameters are signaled to the UEs 120.

When the UEs 120 receive the transition signaling (e.g., in steps 802 or 806), they may behave in a defined manner. Specifically, upon successfully receiving a group common signaling, a UE 120 behaves according to the indicated activity level/activation level, such as in terms of monitoring RSs (including SSB, TRS, CSI-RS, etc.) and DCIs; in terms of performing measurements (including CSI, RSRP, beam management, etc.); in terms of performing feedback and reporting; and the like. For example, if SSB is activated, then the UE 120 may perform one or more of: cell identification, time/frequency synchronization, AGC based on the SSB, and the like. Similarly, if TRS is activated, then the UE 120 may perform one or more of: time/frequency tracking, AGC based on the TRS, and the like. Likewise, if CSI-RS configured for CSI measurement is activated, then the UE 120 may perform CSI measurement based on the CSI-RS. Similarly, if a TCI state is activated, then the UE 120 may apply the associated QCL assumptions for the associated signals and channels. A UE 120 may be interrupted such that it does not expected to receive or transmit during a transition time for the associated resources. Additionally, a UE 120 may not expect to receive a signal triggering any transition during the minimum dwell time on a Scell.

The base station 110 that sends the signaling of activity level/activation level (e.g., in steps 802 or 806) adjusts the activity level/activation level of the corresponding resources accordingly. The state transition signaling may also indicate or trigger the transmission of certain signals and/or channels to facilitate fast transition at the UE side. For example, SSB, TRS, CSI-RS, etc. may be triggered for a UE 120 to detect and measure time/frequency synchronization, AGC, CSI, beam measurement, and the like. The network may be operating in an activity level/activation level without transmitting such signals, such as SSB/TRS, during which the UEs 120 are not expected to receive SSB/TRS. Then the network may send a signaling on one or more carriers that the UEs 120 are monitoring, the signaling carrying information about the activation of the TRS. Based on the reception time of the signaling, the UEs 120 can expect to receive TRS at a slot with a certain time offset after that. Then after one or multiple bursts of TRS, all resources, signals, and/or channels relying on the TRS are activated.

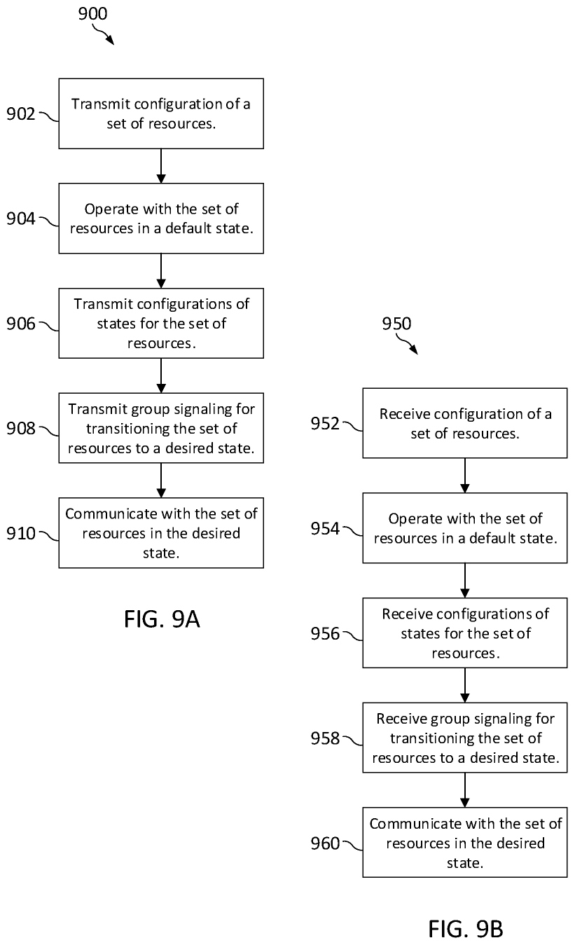

FIG. 9A is a flow diagram of a network adaptation method 900, according to some embodiments. The network adaptation method 900 may be performed by a base station 110.

In step 902, the base station 110 transmits a configuration of a set of resources. The set of resources may be a set of air-interface resources for a group of UEs. The configuration may be transmitted to the group of UEs with group signaling. The set of the air-interface resources may comprise resources of a secondary cell, resources relying on a downlink signal, etc. The downlink signal may be a channel state information reference signal, a tracking reference signal, etc. The tracking reference signal may be a TRS, a CSI-RS for tracking, etc.

In step 904, the base station 110 operates with the set of resources in a default state. The default state may be predetermined, such as in a standards specification.

In step 906, the base station 110 transmits configurations of states for the set of resources to the group of UEs. The configuration may be transmitted to the group of UEs with group signaling. The group signaling may be transmitted by transmitting a group-common downlink control information signal, a MAC CE, etc. The group signaling may include an activity level identifier, an increase or decrease in activity level, parameters of the desired state, etc.

In step 908, the base station 110 transmits group transition signaling for transitioning the set of resources to a desired state of the previously configured states. The transition signaling is transmitted to the group of UEs. After the group transition signaling, the base station 110 performs the state transition. The state transition may be performed by activating/deactivating some of the resources of the group of resources, and activating/deactivating other resources that rely on that activated/deactivated resources. During the state transition, there may be an interruption period on at least the set of resources. A wait may be performed during the interruption period. The duration of the wait may be predetermined, such as in a standards specification.

In step 910, after the interruption period, the base station 110 operates with the set of resources in the desired state, such as by communicating with the UEs with the set of resources in the desired state. The state change may be completed in slot n+k+Δtᵢⱼ, where n is the slot when the transition signaling is transmitted, k is the duration of the interruption, the Δtᵢⱼ is the transition time for the desired state (previously described).

The network adaptation method 900 may include additional steps (not separately illustrated). For example, the base station 110 may receive a feedback and assistance information report from a UE. The base station 110 may select a new state based on the report, transmit group transition signaling for transitioning the set of resources to the new state, and then perform a state transition. The base station 110 then operates with the set of resources in the new state.

FIG. 9B is a flow diagram of a network adaptation method 950, according to some embodiments. The network adaptation method 950 may be performed by a UE 120.

In step 952, the UE 120 receives a configuration of a set of resources. The configuration may be that transmitted by the base station 110 in step 902.

In step 954, the UE 120 operates with the set of resources in a default state. The default state may be predetermined, such as in a standards specification.

In step 956, the UE 120 receives configurations of states for the set of resources. The configurations may be those transmitted by the base station 110 in step 906.

In step 958, the UE 120 receives group transition signaling for transitioning the set of resources to a desired state of the previously configured states. The group transition signaling may be that transmitted by the base station 110 in step 908. After the group transition signaling, the UE 120 performs the state transition. During the state transition, there may be an interruption period on at least the set of resources.

In step 960, after the interruption period, the UE 120 operates with the set of resources in the desired state, such as by communicating with the base station 110 with the set of resources in the desired state.

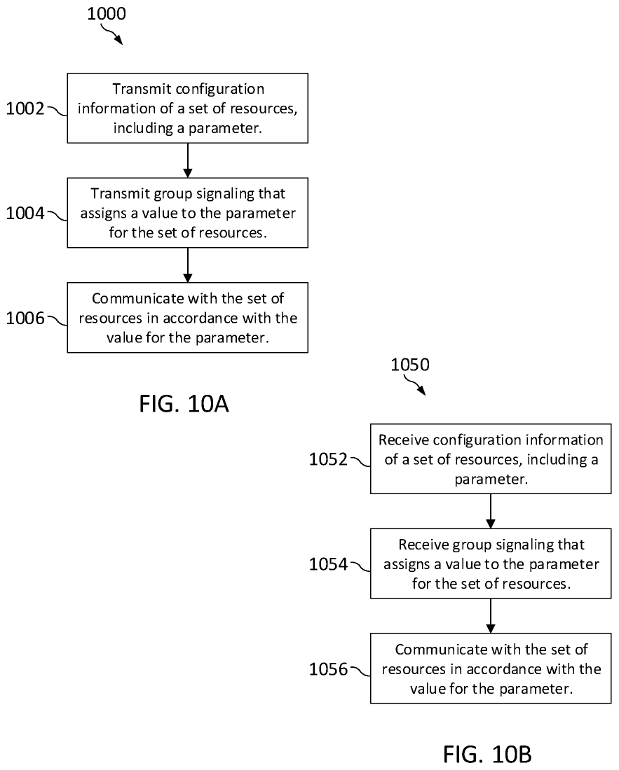

FIG. 10A is a flow diagram of a network adaptation method 1000, according to some embodiments. The network adaptation method 1000 may be performed by a base station 110. Specifically, the network adaptation method 1000 includes additional details that may be performed during the network adaptation method 900.

In step 1002, the base station 110 transmits configuration information of a first set of resources for a UE 120. The configuration information includes a first parameter for the first set of the resources. The first parameter may be a parameter for any resources of the set of resources that will be activated or deactivated by the transition signaling (previously described), such as a cell-specific resource, a common information element, a SSB/MIB/SIB, a TRS/CSI-RS/SRS, etc. For example, the configuration information may indicate to the UE 120 that the periodicity of a resource is a parameter will be subsequently changed, but does not indicate the value for the periodicity of that resource at this step. The configuration information is the configuration of the states of the first set of the resources.

In step 1004, the base station 110 transmits first group signaling that assigns a first value to the first parameter for the first set of the resources. The first value may be any of the contents of the transition signaling (previously described). The first value is for transitioning the set of resources to a desired state. After the group transition signaling, the base station 110 performs the state transition. Continuing the previous example where the configuration information indicated that the periodicity of a resource is a parameter, the first group signaling includes the value for the periodicity of that resource.

In step 1006, the base station 110 communicates with the first set of the resources in accordance with the first value for the first parameter. For example, the first set of the resources may be activated/deactivated in accordance with the first value.

Additional steps (not separately illustrated) may be performed. In some embodiments, the base station 110 subsequently transmits second group signaling that assigns a second value to the first parameter for the first set of the resources. The base station 110 may then communicate with the first set of the resources in accordance with the second value for the first parameter. For example, the first set of the resources may be activated/deactivated in accordance with the second value.

Additionally, the base station 110 may communicate with the first set of the resources in accordance with a default value for the first parameter, such as before the first group signaling is transmitted in step 1004. The default value may be configured in several manners. In some embodiments, the configuration information transmitted in step 1002 includes the default value. In some embodiments, the default value is predetermined, such as in a standards specification.

FIG. 10B is a flow diagram of a network adaptation method 1050, according to some embodiments. The network adaptation method 1050 may be performed by a UE 120. Specifically, the network adaptation method 1050 includes additional details that may be performed during the network adaptation method 950.

In step 1052, the UE 120 receives configuration information of a first set of resources from a base station 110. The configuration information may be that transmitted by the base station 110 in step 1002.

In step 1054, the UE 120 receives first group signaling that assigns a first value to the first parameter for the first set of the resources. The group signaling may be that transmitted by the base station 110 in step 1004. After the group transition signaling, the UE 120 performs the state transition.

In step 1056, the UE 120 communicates with the first set of the resources in accordance with the first value for the first parameter. For example, the first set of the resources may be activated/deactivated in accordance with the first value.

Additional steps (not separately illustrated) may be performed. In some embodiments, the UE 120 subsequently receives second group signaling that assigns a second value to the first parameter for the first set of the resources. The UE 120 may then communicate with the first set of the resources in accordance with the second value for the first parameter. For example, the first set of the resources may be activated/deactivated in accordance with the second value.

Additionally, the UE 120 may communicate with the first set of the resources in accordance with a default value for the first parameter, such as before the first group signaling is received in step 1054. The default value may be configured in several manners. In some embodiments, the configuration information received in step 1052 includes the default value. In some embodiments, the default value is predetermined, such as in a standards specification.

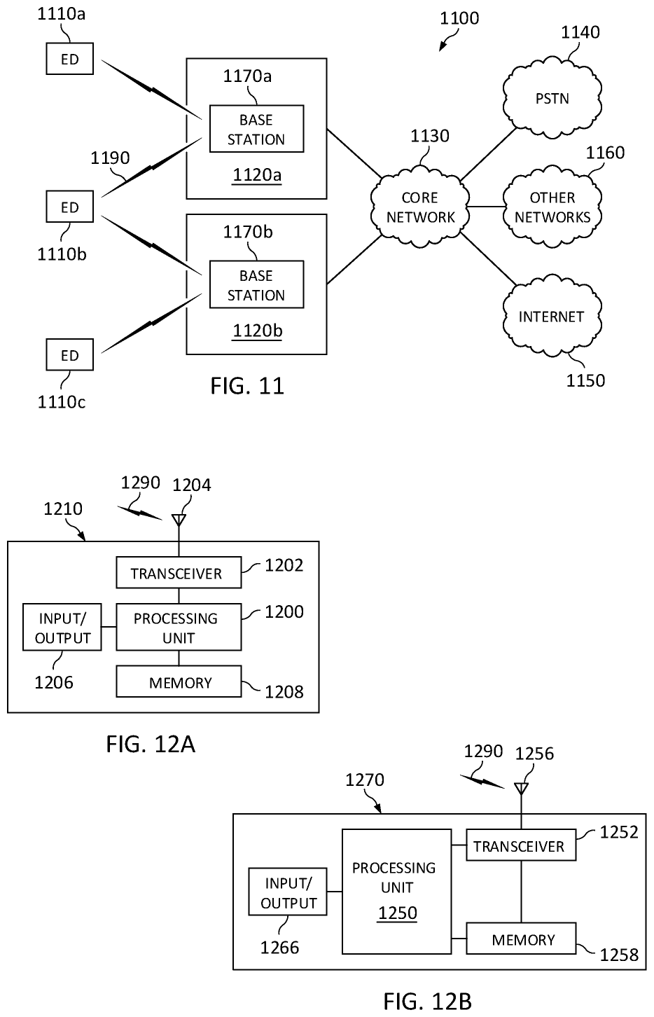

FIG. 11 illustrates an example of a communication system 1100. In general, the communication system 1100 enables multiple wireless or wired users to transmit and receive data and other content. The communication system 1100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1100 includes electronic devices (ED) 1110a-1110c, radio access networks (RANs) 1120a-1120b, a core network 1130, a public switched telephone network (PSTN) 1140, the Internet 1150, and other networks 1160. While certain numbers of these components or elements are shown in FIG. 11, any number of these components or elements may be included in the communication system 1100.

The EDs 1110a-1110c are configured to operate or communicate in the communication system 1100. For example, the EDs 1110a-1110c are configured to transmit or receive via wireless or wired communication channels. Each ED 1110a-1110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1120a-1120b here include base stations 1170a-1170b, respectively. Each base station 1170a-1170b is configured to wirelessly interface with one or more of the EDs 1110a-1110c to enable access to the core network 1130, the PSTN 1140, the Internet 1150, or the other networks 1160. For example, the base stations 1170a-1170b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1110a-1110c are configured to interface and communicate with the Internet 1150 and may access the core network 1130, the PSTN 1140, or the other networks 1160.

In the embodiment shown in FIG. 11, the base station 1170a forms part of the RAN 1120a, which may include other base stations, elements, or devices. Also, the base station 1170b forms part of the RAN 1120b, which may include other base stations, elements, or devices. Each base station 1170a-1170b operates to transmit or receive wireless signals within a particular geographic region or area, sometimes referred to as a “cell.” In some embodiments, multiple-input multiple-output (MIMO) technology may be employed having multiple transceivers for each cell.

The base stations 1170a-1170b communicate with one or more of the EDs 1110a-1110c over one or more air interfaces 1190 using wireless communication links. The air interfaces 1190 may utilize any suitable radio access technology.

It is contemplated that the communication system 1100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1120a-1120b are in communication with the core network 1130 to provide the EDs 1110a-1110c with voice, data, application, Voice over Internet Protocol (VoIP), or other services. Understandably, the RANs 1120a-1120b or the core network 1130 may be in direct or indirect communication with one or more other RANs (not shown). The core network 1130 may also serve as a gateway access for other networks (such as the PSTN 1140, the Internet 1150, and the other networks 1160). In addition, some or all of the EDs 1110a-1110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1150.

Although FIG. 11 illustrates one example of a communication system, various changes may be made to FIG. 11. For example, the communication system 1100 could include any number of EDs, base stations, networks, or other components in any suitable configuration.

FIGS. 12A and 12B illustrate example devices that may implement the methods and teachings according to this disclosure. In particular, FIG. 12A illustrates an example ED 1210, and FIG. 12B illustrates an example base station 1270. These components could be used in the communication system 1100 or in any other suitable system.

As shown in FIG. 12A, the ED 1210 includes at least one processing unit 1200. The processing unit 1200 implements various processing operations of the ED 1210. For example, the processing unit 1200 could perform signal coding, data processing, power control, input/output processing, or any other functionality enabling the ED 1210 to operate in the communication system 1100. The processing unit 1200 also supports the methods and teachings described in more detail above. Each processing unit 1200 includes any suitable processing or computing device configured to perform one or more operations. Each processing unit 1200 could, for example, include a microprocessor, microcontroller, digital signal processor, field programmable gate array, or application specific integrated circuit.

The ED 1210 also includes at least one transceiver 1202. The transceiver 1202 is configured to modulate data or other content for transmission by at least one antenna 1204 or NIC (Network Interface Controller). The transceiver 1202 is also configured to demodulate data or other content received by the antenna 1204. Each transceiver 1202 includes any suitable structure for generating signals for wireless or wired transmission or processing signals received wirelessly or by wire. Each antenna 1204 includes any suitable structure for transmitting or receiving wireless or wired signals. One or multiple transceivers 1202 could be used in the ED 1210, and one or multiple antennas 1204 could be used in the ED 1210. Although shown as a single functional unit, a transceiver 1202 could also be implemented using at least one transmitter and at least one separate receiver.

The ED 1210 further includes one or more input/output devices 1206 or interfaces (such as a wired interface to the Internet 1150). The input/output devices 1206 facilitate interaction with a user or other devices (network communications) in the network. Each input/output device 1206 includes any suitable structure for providing information to or receiving information from a user, such as a speaker, microphone, keypad, keyboard, display, or touch screen, including network interface communications.

In addition, the ED 1210 includes at least one memory 1208. The memory 1208 stores instructions and data used, generated, or collected by the ED 1210. For example, the memory 1208 could store software or firmware instructions executed by the processing unit 1200 and data used to reduce or eliminate interference in incoming signals. Each memory 1208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 12B, the base station 1270 includes at least one processing unit 1250, at least one transceiver 1252, which includes functionality for a transmitter and a receiver, one or more antennas 1256, at least one memory 1258, and one or more input/output devices 1266 or interfaces. A scheduler, which would be understood by one skilled in the art, is coupled to the processing unit 1250. The scheduler could be included within or operated separately from the base station 1270. The processing unit 1250 implements various processing operations of the base station 1270, such as signal coding, data processing, power control, input/output processing, or any other functionality. The processing unit 1250 can also support the methods and teachings described in more detail above. Each processing unit 1250 includes any suitable processing or computing device configured to perform one or more operations. Each processing unit 1250 could, for example, include a microprocessor, microcontroller, digital signal processor, field programmable gate array, or application specific integrated circuit.

Each transceiver 1252 includes any suitable structure for generating signals for wireless or wired transmission to one or more EDs or other devices. Each transceiver 1252 further includes any suitable structure for processing signals received wirelessly or by wire from one or more EDs or other devices. Although shown combined as a transceiver 1252, a transmitter and a receiver could be separate components. Each antenna 1256 includes any suitable structure for transmitting or receiving wireless or wired signals. While a common antenna 1256 is shown here as being coupled to the transceiver 1252, one or more antennas 1256 could be coupled to the transceiver(s) 1252, allowing separate antennas 1256 to be coupled to the transmitter and the receiver if equipped as separate components. Each memory 1258 includes any suitable volatile or non-volatile storage and retrieval device(s). Each input/output device 1266 facilitates interaction with a user or other devices (network communications) in the network. Each input/output device 1266 includes any suitable structure for providing information to or receiving/providing information from a user, including network interface communications.

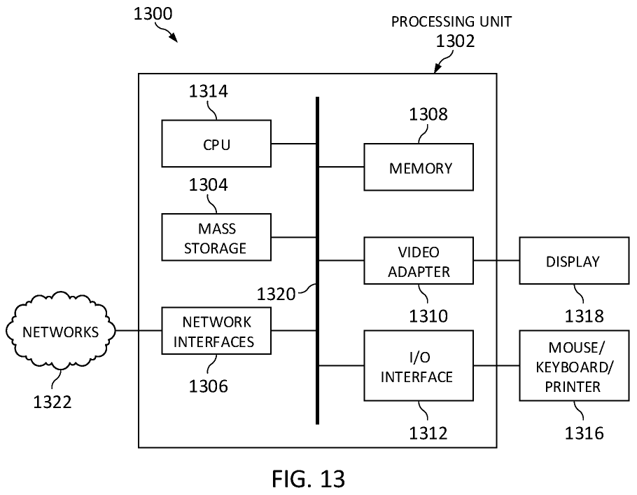

FIG. 13 is a block diagram of a computing system 1300 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1300 includes a processing unit 1302. The processing unit includes a central processing unit (CPU) 1314, memory 1308, and may further include a mass storage device 1304, a video adapter 1310, and an I/O interface 1312 connected to a bus 1320.

The bus 1320 may be one or more of any type of several bus architectures including a memory bus or memory controller, a peripheral bus, or a video bus. The CPU 1314 may comprise any type of electronic data processor. The memory 1308 may comprise any type of non-transitory system memory such as static random access memory (SRAM), dynamic random access memory (DRAM), synchronous DRAM (SDRAM), read-only memory (ROM), or a combination thereof. In an embodiment, the memory 1308 may include ROM for use at boot-up, and DRAM for program and data storage for use while executing programs.

The mass storage device 1304 may comprise any type of non-transitory storage device configured to store data, programs, and other information and to make the data, programs, and other information accessible via the bus 1320. The mass storage device 1304 may comprise, for example, one or more of a solid state drive, hard disk drive, a magnetic disk drive, or an optical disk drive.

The video adapter 1310 and the I/O interface 1312 provide interfaces to couple external input and output devices to the processing unit 1302. As illustrated, examples of input and output devices include a display 1318 coupled to the video adapter 1310 and a mouse, keyboard, or printer 1316 coupled to the I/O interface 1312. Other devices may be coupled to the processing unit 1302, and additional or fewer interface cards may be utilized. For example, a serial interface such as Universal Serial Bus (USB) (not shown) may be used to provide an interface for an external device.

The processing unit 1302 also includes one or more network interfaces 1306, which may comprise wired links, such as an Ethernet cable, or wireless links to access nodes or different networks. The network interfaces 1306 allow the processing unit 1302 to communicate with remote units via the networks. For example, the network interfaces 1306 may provide wireless communication via one or more transmitters/transmit antennas and one or more receivers/receive antennas. In an embodiment, the processing unit 1302 is coupled to a local-area network 1322 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a communicating unit/module, a deactivating unit/module, an activating unit/module, and/or a suspending unit/module. The respective units/modules may be hardware, software, or a combination thereof. For instance, one or more of the units/modules may be an integrated circuit, such as field programmable gate arrays (FPGAs) or application-specific integrated circuits (ASICs).

Additional embodiments related to energy/power states are contemplated.

In TR38.840, the UE power consumption model power state consists of three different sleep states: deep sleep, light sleep, and micro sleep. This is in addition of the four other power states consisting of PDCCH-only, SSB or CSI-RS processing, PDCCH+PDSCH and UL. Furthermore, additional transition energy and total transition time (see Table 19 of TR38.840) for the three sleep states were adopted as working assumptions during the UE power saving study phase.

In RAN1 #109-e, a preliminary understanding of the BS power consumption model was reached. For evaluation purpose, the energy consumption modeling for a BS includes at least the following: a reference configuration (note FR1 and FR2 to be separately considered for detailed parameters); multiple power state(s) including sleep/non-sleep mode(s) with relative power, and associated transition time/energy; and a scaling method to be applied at least for non-sleep mode.

For the network/gNB power consumption model, a similar approach as in the UE consumption model can be adopted. However, other adaptations towards the BS operations should be considered. Starting from the extensive list, the possible BS power consumption states can be listed and described as: Complete Off (this represents a shutdown scenario where all TX/RX/BH are turned OFF); Deep Sleep (TX/RX turned OFF, gNB monitors BH for trigger to turn ON; Light Sleep (TX turned OFF, gNB monitors UL WUS and BH for trigger to turn ON); RACH-only (TX turned OFF, gNB monitors RACH for trigger to turn ON); TX/RX ON (Default ON, all TX/RX/BH are turned ON).

By default, Complete OFF and TX/RX ON states correspond to legacy gNB power consumption operation. If only these two states are present, then it corresponds to the scenario that there is no additional implementation of fine or coarse adaptation of the gNB transmit power relative to what that are already supported in current specifications.

This disclosure considers the practicality of the three sleep states using an example of a conceptual gNB that can support maximum N antenna ports and M component carriers. In its TX/RX ON state, it can adapt among a finite number of configurations between a minimum configuration of n antenna ports and m component carriers and its maximum configuration based on traffic demand or other factors. Adapting the number of antenna ports affords the BS opportunity to turn on/off TRXs for network energy saving.

When the BS is in its minimum configuration, additional techniques such as common signals transmissions reduction whereby the TRX on/off slots/symbols etc., with the UE OFF period can be deployed to further increase the energy saving. Similarly, further energy savings such as frequency adaptation through optimizing the number of component carriers can also be implemented. If the component carriers are supported through shared RF chains, then adapting the number of component carriers can be viewed as some form of bandwidth scaling. It may also be assumed that all the component carriers that are turned on share the same number of antenna ports unless there is compelling reason not to. Therefore, transition between different configurations involves either turning the TRXs on/off, or scaling the bandwidth of the TRXs, or both.

An observation is that a BS power consumption in Light Sleep state can be the result of the BS implementing the various combinations of power savings techniques such as by minimizing the usage of TRXs, common signals transmissions, and/or frequency or bandwidth.

Another observation is that a BS power consumption in Light Sleep State is characterized by its Li RX that is still operational and only the TX chain has been turned off.

In RAN1 #109-e, the desire for separating the DL and UL in terms of BS power consumption has been raised. For evaluation, at least for non-sleep mode and TDD, the BS power consumption for DL and UL are separately modelled, allowing DL-only transmission or UL-only reception.

In the context of the BS sleep states, whether to treat UL and DL separately would depend on the need to separate UL reception state as in RACH-only (previously described). The need to treat them separately might be needed if the UL power consumption is a not insignificant compared to the DL. However, relatively speaking, BS power consumption is mostly about the power need on the DL. Defining a separate UL sleep state (e.g., RACH-only) seems to be just for convenience of discussions.

Another observation is that the motivation for a separate UL-receive only sleep state is not clear. Unless the motivation is justified, there is no need to separately consider the DL-only and UL-only transmissions for the BS power consumption. The RACH-only state would not be needed in this case.

In some embodiments, a power consumption model for the BS that incorporates both the UL and DL in a single model is supported. While the light sleep state is still monitoring the UL reception, a deep sleep state can be defined where no air interface or Li monitoring is required i.e., both the TX and RX processing of gNB have been turned off. In this state, power adaptation is activated and/or deactivated through backhaul signaling such as in the form UE assistance data that is signaled through the backhaul from another gNB. An example of possible use case would be the use of SUL in addition to the dedicated UL carrier to improve UL coverage.

Another observation is that a Deep Sleep state is defined by a BS state of operation whereby no air interface or Li monitoring is required since both the TX and RX processing of gNB have been turned off.

Based on the above discussions and considerations on the BS power states, this disclosure proposes, in some embodiments, two sleep states consisting of the Deep Sleep and Light Sleep States to represent the BS different power consumption levels. Hence for evaluation purposes, the following states should be supported for the BS power consumption.

In some embodiments, the following BS power consumption states are supported for evaluation purposes: State 0 (Complete Off, all TX/RX/BH are turned OFF); State 1 (Deep Sleep and TX/RX turned OFF, BH is turned ON); State 2 (Light Sleep, TX turned OFF, RX and BH are turned ON); and State 3 (ON, a set of TX/RX, and BH are turned ON (to the desired active configuration)).

Next, this disclosure considers the mechanism to transition these two sleep states to the ON state and between each other using a Wake Up Signal (WUS) in the UL. If the WUS consists of a train of RF pulses and the WUS radio at the BS is a separate low power radio using envelope detection to receive the signal, then at least from BS implementation, it may be possible to receive the WUS even when the BS is in the Deep Sleep State, in addition to the Light Sleep State, since the difference in power consumption at the BS is not significant. The support of WUS reception at the BS can be a feature that could be advantageous for small cell BS. Thus, the following definition for the Deep Sleep State may be used: TX and RX turned OFF, gNB monitors BH and/or UL WUS for a trigger to turn ON. The Light Sleep State is differentiated from the Deep Sleep State in terms of its RX being turned ON. Thus, the following definition for the Light Sleep State may be used: TX turned OFF, gNB monitors UL and/or WUS for a trigger to turn ON.

Another observation is that depending on the definition of WUS and network implementation of the WUS receiver, the WUS can be received either at the Deep Sleep or/and Light Sleep states. When the WUS is received in either the Deep or Light sleep states, the BS transitions to the ON state (State 4).

Another observation is that the WUS can provide a quick signaling method for both Deep and Light Sleep States to transition to the default ON state (State 3). As proposed above, when the gNB receives a WUS in a specific cell, the cell transitions from either the Deep (State 1) or Sleep (State 2) states into the ON state (State 3). Absence in receiving this WUS in its own cell, a cell in Deep Sleep State (State 1) should also be able to transition to Light Sleep State (State 2) to allow its UL receiver to be turned on.

Another observation is that the transition to the Light sleep state from Deep sleep state should be supported. This can be supported by a signaling or trigger sent over the BH. The allowed transitions between the above proposed States is illustrated in FIG. 4. The power consumption states as described above should be applicable at the Cell level, meaning a single power consumption model applies to the whole cell or even across multiple cells. A different model or models may not be applied to different CCs supported within the cell.

Another observation is that a single BS power consumption model is applicable across the Cell and/or Multi-Cell. In RAN1 #109-e, whether to compute the BS power at the symbol or slot was also discussed. For evaluation, the BS energy consumption model should at least include the power consumption of BS on slot-level. Note that symbol-level power consumption to reflect different BW (or RB utilization)/time-occupancy/TX-RX direction of different symbols in a slot is considered. System simulation evaluations can be per slot regardless of detailed approach for calculating symbol-level power consumption.

The BS power calculation at slot level with symbol scaling is straightforward at least in terms of evaluating the benefit of time domain adaptations. However, it should be noted that it could be technically possible to reduce the power amplifier (PA) quiescent power dissipation at the symbol level since envelop tracking PAs amplifying wideband signals have existed for some time. Depending on the network/gNB implementations, symbol level power calculations could be supported as well.

Another observation is that slot-level calculation of the BS power consumption is supported.

To complete the BS power consumption model, in addition to the definition of the different power states, the relative power and the transition between any two states may be defined. Some embodiments define sleep modes and determine the characteristics for each mode from one or multiple of the below: relative power; transition time; transition energy; etc. Other approaches are not precluded. It should be appreciated that BS components that can be turned off can be considered when defining the specific values of the characteristics for sleep modes. Some embodiments define sleep mode for DL(TX) and UL(RX) jointly or separately. Some embodiments assume an order for BS entering/resuming from a sleep mode to another mode (sleep or non-sleep) and the associated transition time and energy, i.e. state machine which may have impact on the transition energy.

Some embodiments consider the scaling in a BS energy consumption model based on one or more of the following: number of used physical antenna elements, or TX/RX RUs; occupied BW/RBs for DL and/or UL in a slot/symbol in one CC; number of CCs in CA; number of TRPs; PSD or transmit power; number of DL and/or UL symbols occupied within a slot; or the like. Additional scaling factors may also be utilized.

In the previous section, this disclosure provided the view and proposed a BS power consumption model that consists of two Sleep States (Light and Deep) that represents the gNB/network power consumptions, with differences between the two being the UL reception. Either of the two Sleep States is sufficient to model the different BS power consumptions due to the different power adaptations (TRX on/off, bandwidth etc.) in the DL. Many of these techniques can be implemented without or with minor additional changes to existing Rel-17 specifications. These considerations on the necessary specification's enhancements are discussed elsewhere.

As an example, the mapping between TRX and antenna ports should not impact the Standards. The presence or absence of signal from one port should not impact the radiation pattern/power level of any other ports. However, the mapping does impact the energy saving benefit. For example, in a mapping where each port corresponds to a different set of TRXs; turning off ports affords opportunity to save energy by turning off those associated TRXs. When each port is mapped to the same set of TRXs, turning of a subset of the ports does not allow the TRXs to be turned off.

In another example, mapping between TRX and physical antenna elements should not impact the Standards since such mapping is purely passive. However, the mapping between TRX and antenna ports and physical antenna elements determines the radiation pattern/power level of the antenna ports. With regards to RF sharing consideration, a straightforward implementation would be with PA sharing. If the component carriers share the same PA, then the power scaling should be the same as the bandwidth scaling. If CCs use separate RF paths, then it's equivalent to additional TRXs.

Another observation is that the power savings associated with the Light Sleep State (State 2) is a function of the various gNB/network power savings techniques such as on the mapping among the TRXs/Antenna Ports/Elements.

In some embodiments, details or assumptions of the different power savings techniques deployed are provided or accompany the evaluation results to justify the different power consumption levels of the various sub-state(s) within the Sleep States and possibly also for the ON State.

The approaches listed above have been proposed to address the higher power consumption of NR base stations which is multiple times greater than LTE base stations, principally due to the larger number of TX/RX channels, larger bandwidth, and the higher transmission powers. However, it should be noted that NR has been designed with a much higher spectral efficiency compared to LTE, such as by having lean carrier/signals and efficient control messages. Various methods to efficiently adapt the transmissions of the following channels have been proposed: common channels/signals (e.g., SSB, SIB1, other SI, paging, PRACH); periodic and semi-persistent signals and channel configurations such as CSI-RS, group-common/UE-specific PDCCH, SPS PDSCH, PUCCH carrying SR, PUCCH/PUSCH carrying CSI reports, PUCCH carrying HARQ-ACK for SPS, CG-PUSCH, SRS, positioning RS (PRS), etc.; semi-static and/or dynamic cell on/off in one or more granularity (e.g., subframe/slot/symbol).

Another observation is that for most of the enhancements above, some basic specification support exists since Release 15 NR. For example, turning the cell on/off can be performed with existing gNBs and can be part of the network implementations options. Similarly, for the common signals SIB1, the transmissions or repetition within the 160 ms is within network control as well. Note that the SSB periodicity can be varied from 20 ms up to 160 ms. Current NR can selectively transmit a subset of the SSBs and inform UE of which SSBs are transmitted and not transmitted through an RRC IE ssb-PositionInBurst. Informing UE or UEs through dedicated RRC signaling would incur high power and signaling overhead.

Rel-17 supports cell on/off via SCell activation/deactivation (enabled by standards) and turning on/off the associated network hardware (enabled by gNB implementation). However, this is not efficient. The MAC CE for SCell activation/deactivation is a UE-specific signaling, and hence it must be sent to all the impacted UEs one by one, which consumes excessive signaling overhead and network/UE energy.

For a UE configured with C-DRX, the UE is configured with a predetermined-ON duration within a C-DRX cycle. In practice, the gNB usually configures the same C-DRX cycle among UEs, and multiple ON durations to distributed UEs in time domain. From the gNB perspective, C-DRX can also achieve NW energy saving purpose if the gNB can align the OFF periods from all UEs in a same location.

Next, this disclosure considers the existing support of periodic/semi-persistent (S/SP) physical layer resources in both UL and DL such as CSI-RS and SRS. Both are reference signals for DL and UL, respectively, and configured through RRC for various uses such as measuring and reporting beam signal quality when configured associated with different beams. Similarly, numerous configurations and reconfigurations are needed when identical CSI-RS is configured for all the UE(s) served by a single TRP.

Embodiments may further reduce the SSB and SIB1 transmissions. Any potential reductions should be accompanied with signaling that informs the UE of the reduced transmissions by the gNB/network and it is important that signaling overhead of doing so is minimized as well. This can be achieved by group signaling such as group signaling for handover, group signaling for SSB periodicity update, group signaling for adapting gNB transmission power (via, e.g., updating ss-PBCH-BlockPower or powerControlOffsetSS), etc.

With possible Cell On/Off adaptation, the UEs may still expect/attempt to receive in DL and/or transmit in UL if they are not informed of an off period of the cell. This could result in higher power consumption for the DL as well as higher transmit power if the UE(s) now need to access a cell that is further away or in less favorable conditions.

With the proposed techniques above, enabling group common signaling will reduced the amount of potential signaling overhead. Using a group-common DCI/MAC to inform the UEs all at once may be advantageous. UE grouping may be enhanced, such as by treating all UEs served by a cell (or a set of cells, or a TRP, or a specific network resource) as a group.

Another observation is that support of selective transmission/reception of SSB and SIB1 should be enhanced with group-common or cell-common signaling to the UE(s) on the changes in the SSB/SIBs transmissions. As with the signaling to support efficient Cell or channels on/off described above, CSI-RS would benefit from cell-level deactivation (and activation) signaling as opposed to UE-specific deactivation (and activation) signaling. This would enable group of cells with shared-PA carriers with fast on/off signaling, with potential to reduce the bandwidth switching delays.

Another observation is that Group-common or cell-common signaling of CSI-RS would provide an efficient signaling that supports bandwidth adaptation for network energy savings. With bandwidth adaptation, the network should inform the UE(s) of any reduction/expansion of the bandwidth so that the UE(s) can benefit from this adaptation as well by changing its receiving bandwidth. For example, cell/carrier 1 may be configured as a SCell for UE 1, UE 2, and UE 3. When the hardware for cell 1 is to be turned off (or is entering a mode that does not transmit or receive over-the-air transmissions), the network can send a (group) signaling to UE 1, UE 2, and UE 3 to deactivate cell 1 for the UEs. All resources configured for each of the UEs associated with cell 1 will be deactivated, including all physical signals in all UL BWPs and all DL BWPs of cell 1, all physical channels in all UL BWPs and all DL BWPs of cell 1, and all monitoring/processing operations by the UEs for cell 1 (except possibly some long-periodicity SSB/DL RS processing to maintain the RRM measurement).

In some embodiments, UE grouping and group common signaling to support efficient network resource adaptation is supported.

This disclosure will have sub-cell level adaptations approaches where it is not required the cell(s) to be completely turned off or deactivation. Continuing with the approaches provided above, the DL signal may be a SSB with an index, a CSI-RS resource/resource set/resource setting, a TRS, etc. The DL signal may be associated with a beam, which is enabled by a subset of RF components, such as a subset of gNB antenna panels, a subset of gNB PAs, etc. In another example, cell 1 may include 2 beams (e.g., 2 SSBs, SSB 0 and SSB 1) and SSB 1 is configured for UE 1, UE 2, and UE 3.

When the hardware for SSB 1 is to be turned off (or entering a mode that does not transmit or receive air interface transmissions), the network can send a (group) signaling to UE 1, UE 2, and UE 3 to deactivate SSB 1 for the UEs. When SSB 1 is deactivated, all signals/channels/resources/operations relying on SSB 1 are also deactivated, such as all the CSI-RS/TRS/PDCCH/PDSCH that are QCLed to SSB 1 directly or via another signal, as well as SRS/PUCCH/PUSCH that rely on SSB 1 as path loss RS, RS of the spatial relation info, or rely on a DL RS which is QCLed to SSB 1.

In some deployments, multicell-level resource adaptation may occur. All resources correspond to those configured for all the served UEs in multiple SCells may undergo adaptation. For example, cell/carrier 1 and cell/carrier 2 may be configured as SCells for UE 1, UE 2, and UE 3. When the hardware for cell 1 and cell 2 is to be turned off (or is entering a mode that does not transmit or receive over-the-air transmissions), the network can send a (group) signaling to UE 1, UE 2, and UE 3 to deactivate cell 1 and cell 2 for the UEs. This is particularly useful if cell 1 and cell 2 are on the same band and hence share at least some common RF/baseband processing hardware, such as cell 1 and cell 2 are in intra-band CA, sharing the same PA, form a SCG, etc. Such cells may be configured as a cell set for the served UEs as the adaptation of the underlying hardware of the cells generally affect all cells in the cell set in a common way.

Another observation is that resource adaptation at the multicell-level can provide an effective adaptation towards network energy savings.

In some embodiments, multicell-level resource adaptation, cell-level resource adaptation, and sub-cell-level resource adaptation are supported.

UE assistance signaling or report can play an important function in supporting accurate and flexible network energy savings management. One example is signaling to support the timely gNB activation and deactivation of the various adaptation based on the projected or existing UL traffic from the UE, e.g., during inactivity periods of the UE's DL and UL.

A DL Wake-Up signal may provide power saving support by signaling to the UE so that the UE can continue to sleep even for its DRX OnDuration when there is no pending or incoming data for the UE. The DL wake-up signal is sent outside of the DRX Active time for one or more UEs using format DCI 2-6 and scrambled by PS-RNTI.

An indication or UE assistance in the UL will similarly assist the gNB decision to adapt its operation such as turning on the cells when Cells On/Off were being deployed. The differences between the UL and DL wake-up signals are considered. The triggering and sending of the DL wake-up signal are left to network's decision as various metrics are available at the network side. For the UL, various factors can cause the UE(s) to request resumption of the network's operation, e.g., turning Cells On or increasing the SSBs/SIB periodicity etc. For other reasons such as the need to send UL traffic, a scheduling request (SR) sent in PUCCH would suffice. As in the Rel-15 SR where RRC is used to configure its scheduling requests, for power saving purposes, the UE can also be configured with parameters associated with a new UL wake-up signal, and based on the gNB configuration and relevant standards, the UE can transmit the UL wake-up signal with potentially different messages under different conditions and for different purposes.

Another observation is that the UE should support being configured through RRC the different conditions/triggers for the UE to send an UL Wake-Up signal.

In some embodiments, assistance information in the form of an UL wake-up signal from the UE to the gNB is supported. Support of a UL wake-up signal that can be specific to different use cases may be utilized.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method comprising:
receiving, by a first user equipment (UE) from a network entity, configuration information for a first serving cell for the first UE;
receiving, by the first UE from the network entity, first downlink control information (DCI) signaling comprising one or more first blocks, each block of the one or more first blocks indicating activating or deactivating a first corresponding cell-level energy saving status indicated by the configuration information for the first serving cell; and
communicating, by the first UE via the network entity with the first serving cell in accordance with the first corresponding cell-level energy saving status, wherein:
the first DCI includes a first corresponding block associated with the first serving cell, the first corresponding block activating the first corresponding cell-level energy saving status, wherein activation of the first corresponding cell-level energy saving status indicates the first serving cell operating at a first cell-level energy saving level.

2. The method of claim 1, wherein the first DCI signaling is a first group-common DCI signaling scrambled by an energy saving radio network temporary identifier (RNTI), and the first UE is configured with a group-common DCI format with the energy saving RNTI and the one or more first blocks.

3. The method of claim 2, wherein the first serving cell is in one or more first serving cells, wherein the first corresponding cell-level energy saving status is for the one or more first serving cells, wherein the group-common DCI format is further for configuring a second UE with the energy saving RNTI and one or more second blocks, and a second serving cell in one or more second serving cells configured for the second UE operates at a second cell-level energy saving level when a second corresponding block indicates activating a second corresponding cell-level energy saving status.

4. The method of claim 1, further comprising:
based on the first corresponding cell-level energy saving status, suspending, by the first UE, communication with a first set of resources of the first serving cell for a duration in accordance with a duration value received from the network entity, wherein the first set of the resources is configured for the first serving cell.

5. The method of claim 4, further comprising:
before receiving the first DCI signaling indicating activating the first corresponding cell-level energy saving status, communicating, by the first UE, using the first set of resources of the first serving cell.

6. A method comprising:
transmitting, by a network entity to a first user equipment (UE), configuration information for a first serving cell for the first UE;
transmitting, by the network entity to the first UE, first downlink control information (DCI) signaling comprising one or more first blocks, each block of the one or more first blocks indicating activating or deactivating a first corresponding cell-level energy saving status indicated by the configuration information for the first serving cell; and
communicating, by the network entity via the first serving cell with the first UE in accordance with the first corresponding cell-level energy saving status, wherein:
the first DCI includes a first corresponding block associated with the first serving cell, the first corresponding block activating the first corresponding cell-level energy saving status, wherein activation of the first corresponding cell-level energy saving status indicates the first serving cell operating at a first cell-level energy saving level.

7. The method of claim 6, wherein the first DCI signaling is a first group-common DCI signaling scrambled by an energy saving radio network temporary identifier (RNTI), and the first UE is configured with a group-common DCI format with the energy saving RNTI and the one or more first blocks.

8. The method of claim 7, wherein the first serving cell is in one or more first serving cells, wherein the first corresponding cell-level energy saving status is for the one or more first serving cells, wherein the group-common DCI format is further for configuring a second UE with the energy saving RNTI and one or more second blocks, and a second serving cell in one or more second serving cells configured for the second UE operates at a second cell-level energy saving level when a second corresponding block indicates activating a second corresponding cell-level energy saving status.

9. The method of claim 6, wherein communication with a first set of resources of the first serving cell is suspended for a duration in accordance with a duration value received from the network entity based on the first corresponding cell-level energy saving status, and wherein the first set of the resources is configured for the first serving cell.

10. The method of claim 9, further comprising:
before transmitting the first DCI signaling indicating activating the first corresponding cell-level energy saving status, communicating, by the network entity, using the first set of resources of the first serving cell.

11. A first user equipment (UE) comprising:
at least one processor; and
a non-transitory computer readable storage medium storing programming, the programming including instructions that, when executed by the at least one processor, cause the first UE to perform operations including:
receiving, from a network entity, configuration information for a first serving cell for the first UE;
receiving, from the network entity, first downlink control information (DCI) signaling comprising one or more first blocks, each block of the one or more first blocks indicating activating or deactivating a first corresponding cell-level energy saving status indicated by the configuration information for the first serving cell; and
communicating, via the network entity with the first serving cell in accordance with the first corresponding cell-level energy saving status, wherein:
the first DCI includes a first corresponding block associated with the first serving cell, the first corresponding block activating the first corresponding cell-level energy saving status, wherein activation of the first corresponding cell-level energy saving status indicates the first serving cell operating at a first cell-level energy saving level.

12. The first UE of claim 11, wherein the first DCI signaling is a first group-common DCI signaling scrambled by an energy saving radio network temporary identifier (RNTI), and the first UE is configured with a group-common DCI format with the energy saving RNTI and the one or more first blocks.

13. The first UE of claim 12, wherein the first serving cell is in one or more first serving cells, wherein the first corresponding cell-level energy saving status is for the one or more first serving cells, wherein the group-common DCI format is further for configuring a second UE with the energy saving RNTI and one or more second blocks, and a second serving cell in one or more second serving cells configured for the second UE operates at a second cell-level energy saving level when a second corresponding block indicates activating a second corresponding cell-level energy saving status.

14. The first UE of claim 11, the operations further comprising:
based on the first corresponding cell-level energy saving status, suspending communication with a first set of resources of the first serving cell for a duration in accordance with a duration value received from the network entity, wherein the first set of the resources is configured for the first serving cell.

15. The first UE of claim 14, the operations further comprising:
before receiving the first DCI signaling indicating activating the first corresponding cell-level energy saving status, communicating using the first set of resources of the first serving cell.

16. A network entity comprising:
at least one processor; and
a non-transitory computer readable storage medium storing programming, the programming including instructions that, when executed by the at least one processor, cause the network entity to perform operations including:
transmitting, to a first user equipment (UE), configuration information for a first serving cell for the first UE;
transmitting, to the first UE, first downlink control information (DCI) signaling comprising one or more first blocks, each block of the one or more first blocks indicating activating or deactivating a first corresponding cell-level energy saving status indicated by the configuration information for the first serving cell; and
communicating, via the first serving cell with the first UE in accordance with the first corresponding cell-level energy saving status, wherein:
the first DCI includes a first corresponding block associated with the first serving cell, the first corresponding block activating the first corresponding cell-level energy saving status, wherein activation of the first corresponding cell-level energy saving status indicates the first serving cell operating at a first cell-level energy saving level.

17. The network entity of claim 16, wherein the first DCI signaling is a first group-common DCI signaling scrambled by an energy saving radio network temporary identifier (RNTI), and the first UE is configured with a group-common DCI format with the energy saving RNTI and the one or more first blocks.

18. The network entity of claim 17, wherein the first serving cell is in one or more first serving cells, wherein the first corresponding cell-level energy saving status is for the one or more first serving cells, wherein the group-common DCI format is further for configuring a second UE with the energy saving RNTI and one or more second blocks, and a second serving cell in one or more second serving cells configured for the second UE operates at a second cell-level energy saving level when a second corresponding block indicates activating a second corresponding cell-level energy saving status.

19. The network entity of claim 16, wherein communication with a first set of resources of the first serving cell is suspended for a duration in accordance with a duration value received from the network entity based on the first corresponding cell-level energy saving status, and wherein the first set of the resources is configured for the first serving cell.

20. The network entity of claim 19, the operations further comprising:
before transmitting the first DCI signaling indicating activating the first corresponding cell-level energy saving status, communicating using the first set of resources of the first serving cell.
